(19) United States
(12) Patent Application Publication
(10) Pub. No.: US 2013/0113892 A1
(43) Pub. Date: May 9, 2013

(54) THREE-DIMENSIONAL IMAGE DISPLAY DEVICE, THREE-DIMENSIONAL IMAGE DISPLAY METHOD AND RECORDING MEDIUM

(71) Applicant: FUJIFILM Corporation, Tokyo (JP)

(72) Inventor: Fumio NAKAMARU, Saitama-shi (JP)

(73) Assignee: FUJIFILM CORPORATION, Tokyo (JP)

(21) Appl. No.: 13/729,309

(22) Filed: Dec. 28, 2012

Related U.S. Application Data
(63) Continuation of application No. PCT/JP2011/062897, filed on Jun. 6, 2011.

(30) Foreign Application Priority Data
Jun. 30, 2010 (JP) 2010-150066

(51) Int. Cl. H04N 13/00

(52) U.S. Cl. CPC H04N 13/0033
USPC 348/47

(57) ABSTRACT

Among objects located more frontward than a main object, an object having a disparity vector having magnitude of a predetermined threshold value or more determined as a target object. A background image for an image for right-eye is extracted from an image for left-eye, and is combined with the image for right-eye. The target object is deleted from the image for right-eye. The target object image is combined at a position in the image for left-eye corresponding to a position of the target object in the image for right-eye to overlappingly display images of the target object in the image for left-eye. The image for right-eye from which the target object image is deleted and the image for left-eye in which the images of the target object are overlappingly displayed are three-dimensionally displayed on a monitor. Accordingly, the target object can be prevented from being viewed as a three-dimensional image.

### CROSS-REFERENCE TO RELATED APPLICATIONS

This application is a PCT Bypass continuation application and claims the priority benefit under 35 U.S.C. §120 of PCT Application No. PCT/JP2011/062897 filed on Jun. 6, 2011 which application designates the U.S., and also claims the priority benefit under 35 U.S.C. §119 of Japanese Patent Application No. 2010-150066 filed on Jun. 30, 2010, which applications are all hereby incorporated by reference in their entireties.

### BACKGROUND OF THE INVENTION

1. Field of the Invention

The present invention relates to a three-dimensional image display device, a three-dimensional image display method, a three-dimensional image display program, and a recording medium, more particularly to a three-dimensional image display device, a three-dimensional image display method and a recording medium capable of displaying a three-dimensional image in consideration of fatigue of a user's eyes.

2. Description of the Related Art

An example of a reproduction scheme of reproducing a three-dimensional image includes a three-dimensional display device employing a parallax barrier system, for example. An image for a left eye and an image for a right eye are respectively resolved into strip pieces in the perpendicular scanning direction of the images, and the resolved strip image pieces are alternatively arranged so as to generate a single image, and if the generated image is overlappingly displayed with perpendicularly extending slits disposed in front of the generated image, the strip images for the left eye are visually recognized by the user's left eye, and the strip images for the right eye are visually recognized by the user's right eye.

FIG. 13A shows a positional relation of an object A, an object B, and an object C relative to a multi-eye camera when an image is three-dimensionally photographed using the multi-eye camera equipped with two imaging systems: a right imaging system for picking up an image for a right eye and a left imaging system for picking up an image for a left eye. A cross point is a position where an optical axis of the right imaging system intersects an optical axis of the left imaging system. The object A and the object B are located closer to the multi-eye camera than (referred to as “frontward than”, hereinafter) the cross point, and the object C is located farther from the multi-eye camera than (referred to as “backward than”, hereinafter) the cross point.

If an image picked up in such a manner is displayed on a three-dimensional device, an object located at the cross point is viewed as if it is displayed on a display plane (amount of parallax is 0), an object located frontward than the cross point is viewed as if it is located in front of the display plane, and an object located backward than the cross point is viewed as if it is located in back of the display plane. Specifically, as shown in FIG. 13B, the object C appears to be in back of the display plane, the object A appears to be a little in front of the display plane, and the object B appears to be popping out of the display plane.

In such three-dimensional display devices using the aforementioned system, particularly with respect to a small portable three-dimensional display device, a distance between the three-dimensional display device and a user (user's eyes) becomes smaller than that in a large three-dimensional display device. Consequently, the object B in FIG. 13B that appears to be greatly popping out of the display plane causes fatigue to the user's eyes because the user is likely to become cross-eyed excessively.

To address this disadvantage, Japanese Patent Application Laid-Open No. 2005-167310 describes a technique that, during reproducing photographed three-dimensional images, displays a photographed three-dimensional image inappropriate as a three-dimensional display using another display scheme (such as a two-dimensional display, or a three-dimensional display corrected by using a smaller parallax so as to reduce the three-dimensional effect).

### SUMMARY OF THE INVENTION

However, there are still disadvantages in Japanese Patent Application Laid-Open No. 2005-167310. 2005-167310 that the three-dimensionality is lost, or the overall three-dimensionality becomes lower in the three-dimensional image.

Another method other than the method disclosed in Japanese Patent Application Laid-Open No. 2005-167310 that prevents a user from becoming cross-eyed excessively may include such a method that adjusts the parallax between an image for the left eye and an image for the right eye such that the most frontward object is displayed on the display plane. Displaying the most frontward object on the display plane, however, requires an adjustment to display every object as if it is located backward than the display plane, which causes difficulties in seeing a distance view (objects located on a backward side).

An object of the present invention, which has been made in order to solve the problems according to the conventional art, is to provide a three-dimensional image display device, a three-dimensional image display method and a recording medium that are capable of preventing a user from becoming cross-eyed excessively, and preventing difficulties in seeing a distance view as well as the fatigue of the user's eyes.

In order to achieve the abovementioned object, the three-dimensional image display device according to the first aspect of the present invention includes acquiring units for acquiring an image for left-eye and an image for right-eye; a display unit for recognizably displaying the image for left-eye and the image for right-eye as a three-dimensional image; a target object extracting unit for extracting from each of the image for left-eye and the image for right-eye at least one object having a parallax in a direction of popping out from a display plane of the display unit (referred to as a target object, hereinafter) when the image for left-eye and the image for right-eye are displayed on the display unit; an image processing unit for carrying out image processing on the image for left-eye and on the image for right-eye based on the target object extracted by the target object extracting unit, on one of the image for left-eye and the image for right-eye (referred to as a first image, hereinafter), the image processing unit carrying out a process of displaying an image of the target object (referred to as a target object image, hereinafter) at two positions, one of which is a position of the target object in the image for left-eye, and the other of which is a position of the target object in the image for right-eye (referred to as a process of overlappingly displaying the target object images, hereinafter), and the image processing unit carrying out a process of deleting the target object image from an image other than the first image of the image for left-eye and the image for right-eye (referred to as a second image, hereinafter), or carrying out a process of overlappingly displaying the target object images in the image for left-eye and in the image for right-eye; and a display controlling unit for displaying the image for left-eye and the image for right-eye to both of which the image processing is applied by the image processing unit.

The three-dimensional image display device according to the first aspect of the present invention performs the following processes of: extracting from each of the image for left-eye and the image for right-eye at least one object having a parallax in a direction of popping out from a display plane of the display unit when the image for left-eye and the image for right-eye are displayed on the display unit (referred to as a target object, hereinafter); on one of the image for left-eye and the image for right-eye (referred to as a first image, hereinafter), displaying an image of the target object (referred to as a target object image, hereinafter) at two positions, one of which is a position of the target object in the image for left-eye, and the other of which is a position of the target object in the image for right-eye; and deleting the target object from an image other than the first image of the image for left-eye and the image for right-eye (referred to as a second image, hereinafter), thereby three-dimensionally displaying the image for right-eye and the image for left-eye after being processed. Accordingly, the target object can be prevented from being viewed as a three-dimensional image.

The three-dimensional image display device according to the first aspect of the present invention extracts at least one object from each of the image for left-eye and the image for right-eye, applies a process of overlappingly displaying the target object images on the image for left-eye and the image for right-eye, thereby three-dimensionally displaying the image for right-eye and the image for left-eye after being processed. Accordingly, the target object can be hindered from being viewed as a three-dimensional image.

Fatigue of a user's eyes can be prevented because the user is unlikely to become cross-eyed excessively. Since no image processing is applied to the rest of the image other than the target object, which eliminates difficulties in seeing a distance view.

According to the second aspect of the present invention, in the three-dimensional image display device according to the first aspect, the target object extracting unit extracts as the target object an object whose parallax in the direction of popping out from the display plane of the display unit is equal to or more than a predetermined magnitude.

In the three-dimensional image display device according to the second aspect, since an object whose parallax in the direction of popping out from the display plane of the display unit is equal to or more than a predetermined magnitude is extracted as the target object, an object whose amount of the popping-out causes no fatigue to the user's eyes can be prevented from being extracted as the target object.

According to the third aspect of the present invention, the three-dimensional image display device of the first and the second aspects further includes a main object extracting unit for extracting at least one main object from each of the image for left-eye and the image for right-eye; and a parallax shifting unit for shifting one of the image for left-eye and the image for right-eye in a horizontal direction so as to allow a position of the main object in the image for left-eye to correspond with a position of the main object in the image for right-eye, and the target object extracting unit extracts the target object from one of the image for left-eye and the image for right-eye after the parallax shifting is performed by the parallax shifting unit, and the image processing unit displays the target object image at two position, one of which is a position of the target object in the image for left-eye after the parallax shifting is performed by the parallax shifting unit, and the other of which is a position of the target object in the image for right-eye after the parallax shifting is performed by the parallax shifting unit, so as to overlappingly display the target object images.

The three-dimensional image display device according to the third aspect of the present invention extracts the target object from each of the image for left-eye and the image for right-eye after the parallax shifting is performed by shifting one of the image for left-eye and the image for right-eye in a horizontal direction so as to allow a position of the main object in the image for left-eye to correspond with a position of the main object in the image for right-eye. In addition the three-dimensional image display device displays the target object image at two position, one of which is a position of the target object in the image for left-eye after the parallax shifting is carried out, and the other of which is a position of the target object in the image for right-eye after the parallax shifting is carried, so as to overlappingly display the target object images at the two positions. In this configuration, the main object is displayed on the display plane, and an object more frontward than the main object can be processed. Since the main object is displayed on the display plane, the user's eyes are focused on the display plane when the user pays attention to the main object. Accordingly, the fatigue of the user's eyes can be further reduced.

According to the fourth aspect of the present invention, the three-dimensional image display device of any one of the first to the third aspects further includes a disparity vector calculating unit that extracts a predetermined object from each of the image for left-eye and the image for right-eye; calculates a disparity vector indicating a deviation of a position of the predetermined object in the second image relative to a position of the predetermined object in the first image as a disparity vector of the predetermined object; and executes the disparity vector calculation on every object included in the image for left-eye and in the image for right-eye, and the target object extracting unit extracts the target object based on the disparity vector calculated on the disparity vector calculating unit.

In the three-dimensional image display device according to the fourth aspect of the present invention, a disparity vector indicating a deviation of the position in the second image relative to the position in the first image is calculated for every object included in the image for left-eye and in the image for right-eye, and the target object is extracted based on the disparity vector. In this configuration, it is possible to readily extract the target object.

According to the fifth aspect of the present invention, in the three-dimensional image display device of the fourth aspect, the image processing unit includes a device for extracting the target object image from the first image, and synthesizing the target object image at a position shifted from the target object image extracted from the first image by the disparity vector calculated for the target object on the disparity vector calculating unit, so as to overlappingly display the target object images in the first image; and a device for extracting the target object image and an image of surroundings of the target object image from the second image, extracting a background of the target object of the second image (referred to as a background image, hereinafter) from the first image based on the image of the surroundings extracted from the second image, and synthesizing the background image extracted from the first image on the target object image extracted from the second image, so as to delete the target object image from the second image.

In the three-dimensional image display device according to the fifth aspect of the present invention, the target object image is extracted from the first image, and the target object image is synthesized at a position shifted from the target object image of the first image by the disparity vector of the target object, so as to overlappingly display the target object images in the first image. In addition, the target object image and an image of surroundings of the target object image are extracted from the second image, a background image of the second image is extracted from the first image based on the image of the surroundings extracted from the second image, the background image extracted from the first image is synthesized on the target object image of the second image, so as to delete the target object image from the second image. In this configuration, the target object can be prevented from being three-dimensionally viewed.

According to the sixth aspect of the present invention, in the three-dimensional image display device of the fifth aspect, the image processing unit extracts the target object image from the first image, and processes the target object image to be semitransparent and synthesizes the semitransparent target object image at a position shifted from the target object image extracted from the first image by the disparity vector calculated for the target object on the disparity vector calculating unit, so as to overlappingly display the target object images in the first image.

The three-dimensional image display device according to the sixth aspect of the present invention extracts the target object image from the first image, processes the target object image to be semitransparent, and synthesizes the semitransparent target object image at a position shifted from the target object image of the first image by the disparity vector of the target object, so as to overlappingly display the target object images in the first image. In this configuration, the main object can be prevented from attracting the user's attention.

According to the seventh aspect of the present invention, in the three-dimensional image display device of the fourth aspect, the image processing unit extracts the target object image from the first image, processes the target object image to be semitransparent and synthesizes the semitransparent target object image at a position shifted from the target object image extracted from the first image by a disparity vector calculated for the target object on the disparity vector calculating unit (referred to as a disparity vector of the target object, hereinafter), extracts the target object image from the second image, and processes the target object image to be semitransparent and synthesizes the semitransparent target object image at a position shifted from the target object image extracted from the second image in a reverse direction to the disparity vector of the target object by a magnitude of the disparity vector of the target object, so as to overlappingly display the target object images in each of the first image and the second image.

The three-dimensional image display device according to the seventh aspect of the present invention, extracts the target object image from the first image, processes the target object image to be semitransparent, and synthesizes the semitransparent target object image at a position shifted from the target object image of the first image by a disparity vector of the target object, so as to overlappingly display the target object images in the first image; and in addition, extracts the target object from the second image, processes the target object image to be semitransparent, and synthesizes the semitransparent target object image at a position shifted from the target object image of the second image in a reverse direction to the disparity vector of the target object by a magnitude of the disparity vector of the target object, so as to overlappingly display the target object images in the second image. In this configuration, the target object can be hindered from being three-dimensionally viewed.

According to the eighth aspect of the present invention, in the three-dimensional image display device of the fourth aspect, the image processing unit includes: a device for extracting the target object image from the first image, processing the target object image to be semitransparent and synthesizes the semitransparent target object image at a position shifted from the target object image extracted from the first image by a disparity vector calculated for the target object on the disparity vector calculating unit (referred to as a disparity vector of the target object, hereinafter), and extracting the target object from the second image, and processing the target object image to be semitransparent and synthesizing the semitransparent target object image at a position shifted from the target object image extracted from the second image in a reverse direction to the disparity vector of the target object by a magnitude of the disparity vector of the target object; and a device for extracting the target object image and an image of surroundings of the target object image from the second image, extracting a background of the target object of the second image (referred to as a background image, hereinafter) from the first image based on the image of the surroundings extracted from the second image, and processing the background image extracted from the first image to be semitransparent, and overlappingly synthesizing the semitransparent background image on the target object image extracted from the second image, and extracting the target object image and an image of surroundings of the target object image from the first image, extracting a background image of the first image from the second image based on the image of the surroundings extracted from the first image, processing the background image extracted from the second image to be semitransparent and overlappingly synthesizing the semitransparent background image on the target object image extracted from the first image.

The three-dimensional image display device according to the eighth aspect of the present invention, extracts the target object image from the first image, processes the target object image to be semitransparent, and synthesizes the semitransparent target object image at a position shifted from the target object image of the first image by a disparity vector of the target object, so as to overlappingly display the target object images in the first image, and extracts the target object from the second image, processes the target object image to be semitransparent, and synthesizes the semitransparent target object image at a position shifted from the target object image of the second image in a reverse direction to the disparity vector of the target object by a magnitude of the disparity vector of the target object, so as to overlappingly display the target object images in the first image. The three-dimensional image display device according to the eighth aspect extracts the target object image and an image of surroundings of the target object image from the second image, extracts a background image of the second image from the first image based on the image of the surroundings extracted from the second image, processes the background image extracted from the first image to be semitransparent, and overlappingly synthesizes the semitransparent background image on the target object image of the second image, and extracts the target object image and an image of surroundings of the target object image from the first image, extracts a background image of the first image from the second image based on the image of the surroundings extracted from the first image, processes the background image of the second image to be semitransparent, and overlappingly synthesizes the semitransparent background image on the target object image of the first image. In this configuration, the target object can be hindered from being three-dimensionally viewed.

According to the ninth aspect of the present invention, in the three-dimensional image display device of any one of the sixth to eighth aspects, the image processing unit varies a degree of the semitransparency based on a size of the target object.

The three-dimensional image display device according to the ninth aspect of the present invention varies a degree of semitransparency based on a size of the target object. In this configuration, it is possible to enhance an effect to prevent or hinder the target object from being three-dimensionally viewed.

The three-dimensional image display method according to the tenth aspect of the present invention includes a step of acquiring an image for left-eye and an image for right-eye; a step of extracting from each of the image for left-eye and the image for right-eye at least one object having a parallax in a direction of popping out from a display plane of a display unit (referred to as a target object, hereinafter) when the image for left-eye and the image for right-eye are displayed on the display unit for recognizably displaying the image for left-eye and the image for right-eye as a three-dimensional image; a step of carrying out image processing on the image for left-eye and on the image for right-eye based on the extracted target object, a step of carrying out, on one of the image for left-eye and the image for right-eye (referred to as a first image, hereinafter), a process of displaying an image of the target object (referred to as a target object image, hereinafter) at two positions, one of which is a position of the target object in the image for left-eye, and the other of which is a position of the target object in the image for right-eye (referred to as a process of overlappingly displaying the target object images, hereinafter), and carrying out a process of deleting the target object image from an image other than the first image of the image for left-eye and the image for right-eye (referred to as a second image, hereinafter), or a process of overlappingly displaying the target object images in the image for left-eye and in the image for right-eye; and a step of displaying the image for left-eye and the image for right-eye to both of which the image processing is applied on the displaying unit.

A computer program including instructions executable on a computer, which can realize each step included in the three-dimensional image display method according to the tenth aspect of the present invention, may also attain the abovementioned object by allowing the computer to execute the program. A computer-readable recording medium storing a computer program can also attain the abovementioned object by installing the computer program in the computer through the recording medium, so as to allow the computer to execute the program.

According to the present invention, it is possible to prevent a user from becoming cross-eyed excessively, and also prevent difficulties in seeing a distance view, thereby preventing the fatigue of the user's eyes.

### BRIEF DESCRIPTION OF THE DRAWINGS

FIG. 1A is a schematic front view of the multi-eye digital camera 1 according to the first embodiment of the present invention.

FIG. 1B is a schematic back view of the multi-eye digital camera 1 according to the first embodiment of the present invention.

FIG. 2 is a block diagram showing an electric configuration of the multi-eye digital camera 1.

FIG. 3 is a block diagram showing an internal configuration of a 3D/2D converter 135 of the multi-eye digital camera 1.

FIG. 4 is a flow chart of the 2D processing of the multi-eye digital camera 1.

FIG. 5A is a drawing explaining the 2D processing of the multi-eye digital camera 1 (No. 1).

FIG. 5B is a drawing explaining the 2D processing of the multi-eye digital camera 1 (No. 2).

FIG. 5C is a drawing explaining the 2D processing of the multi-eye digital camera 1 (No. 3).

FIG. 5D is a drawing explaining the 2D processing of the multi-eye digital camera 1 (No. 4).

FIG. 5E is a drawing explaining the 2D processing of the multi-eye digital camera 1 (No. 5).

FIG. 5F is a drawing explaining the 2D processing of the multi-eye digital camera 1 (No. 6).

FIG. 5G is a drawing explaining the 2D processing of the multi-eye digital camera 1 (No. 7).

FIG. 5H is a drawing explaining the 2D processing of the multi-eye digital camera 1 (No. 8).

FIG. 5I is a drawing explaining the 2D processing of the multi-eye digital camera 1 (No. 9).

FIG. 5J is a drawing explaining the 2D processing of the multi-eye digital camera 1 (10).

FIG. 6 is a block diagram showing an internal configuration of the 3D/2D converter 135 of the multi-eye digital camera 1 according to the second embodiment of the present invention.

FIG. 7 is a flow chart of the 2D processing of the multi-eye digital camera 2.

FIG. 8A is a drawing explaining the 2D processing of the multi-eye digital camera 2 (No. 1).

FIG. 8B is a drawing explaining the 2D processing of the multi-eye digital camera 2 (No. 2).

FIG. 8C is a drawing explaining the 2D processing of the multi-eye digital camera 2 (No. 3).

FIG. 8D is a drawing explaining the 2D processing of the multi-eye digital camera 2 (No. 4).

FIG. 8E is a drawing explaining the 2D processing of the multi-eye digital camera 2 (No. 5).

FIG. 9 is a block diagram showing an internal configuration of the 3D/2D converter 135 of the multi-eye digital camera 3 according to the third embodiment of the present invention.

FIG. 10 is a flow chart of the 2D processing of the multi-eye digital camera 3.

FIG. 11A is a drawing explaining the 2D processing of the multi-eye digital camera 3 (No. 1).

FIG. 11B is a drawing explaining the 2D processing of the multi-eye digital camera 3 (No. 2).

FIG. 11C is a drawing explaining the 2D processing of the multi-eye digital camera 3 (No. 3).

FIG. 11D is a drawing explaining the 2D processing of the multi-eye digital camera 3 (No. 4).

FIG. 11E is a drawing explaining the 2D processing of the multi-eye digital camera 3 (No. 5).

FIG. 11F is a drawing explaining the 2D processing of the multi-eye digital camera 3 (No. 6).

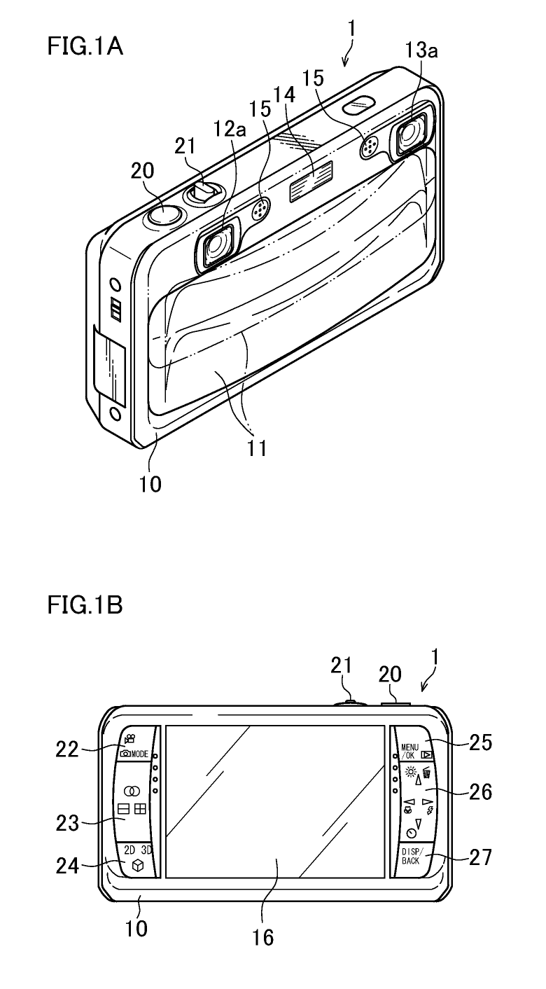

FIG. 1G is a drawing explaining the 2D processing of the multi-eye digital camera 3 (No. 7).

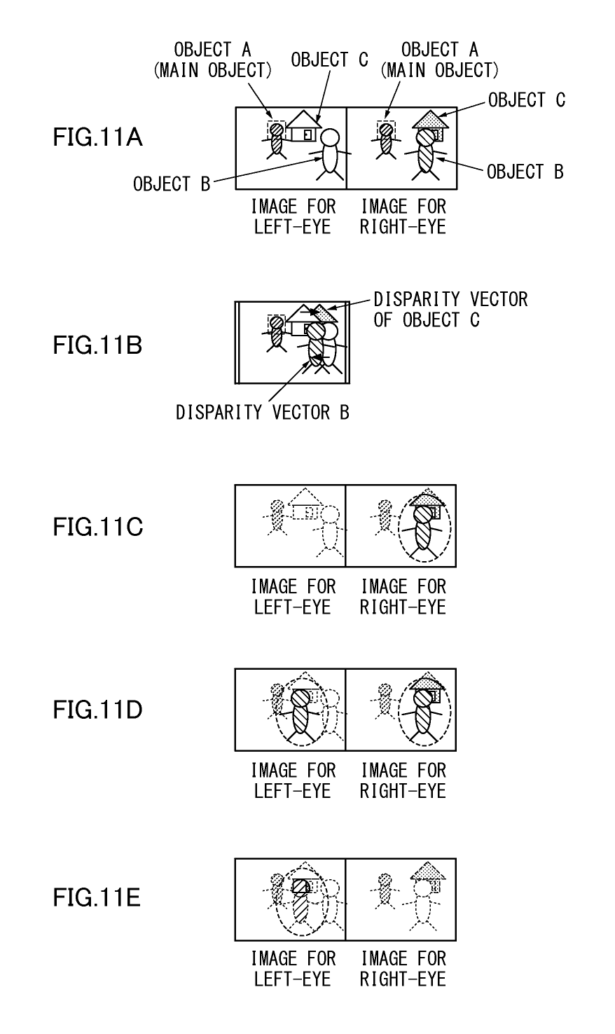

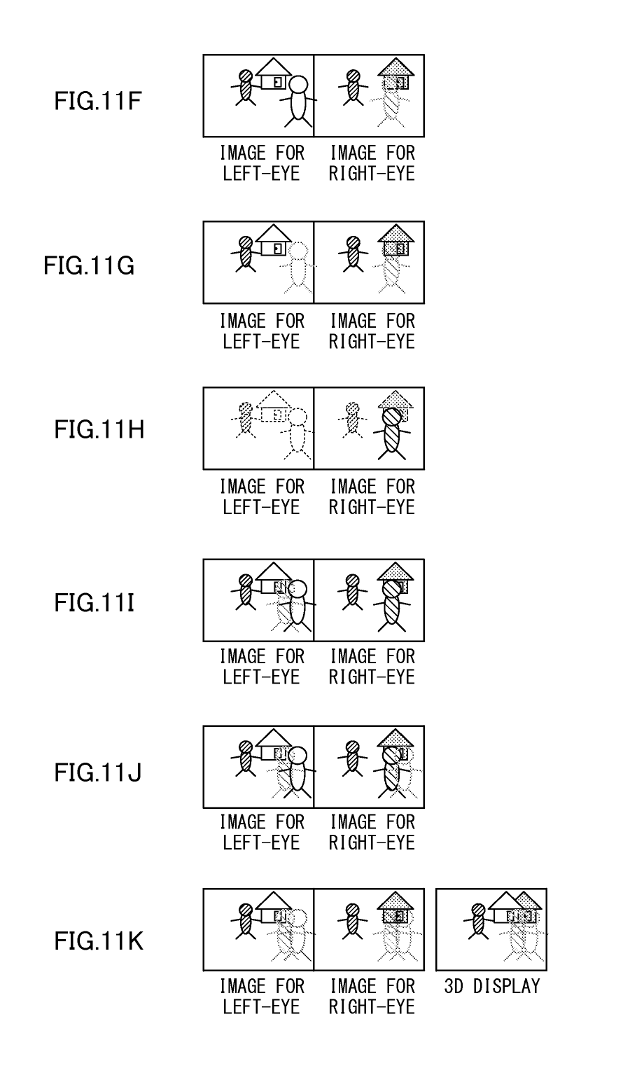

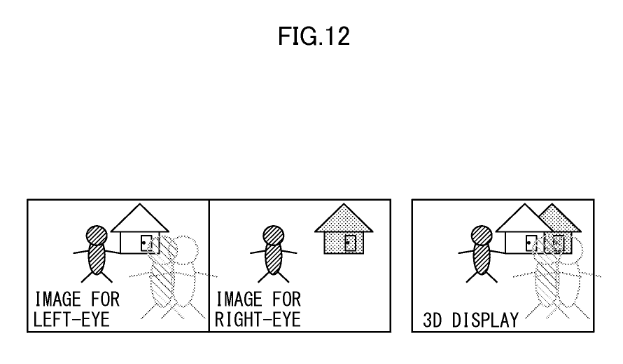

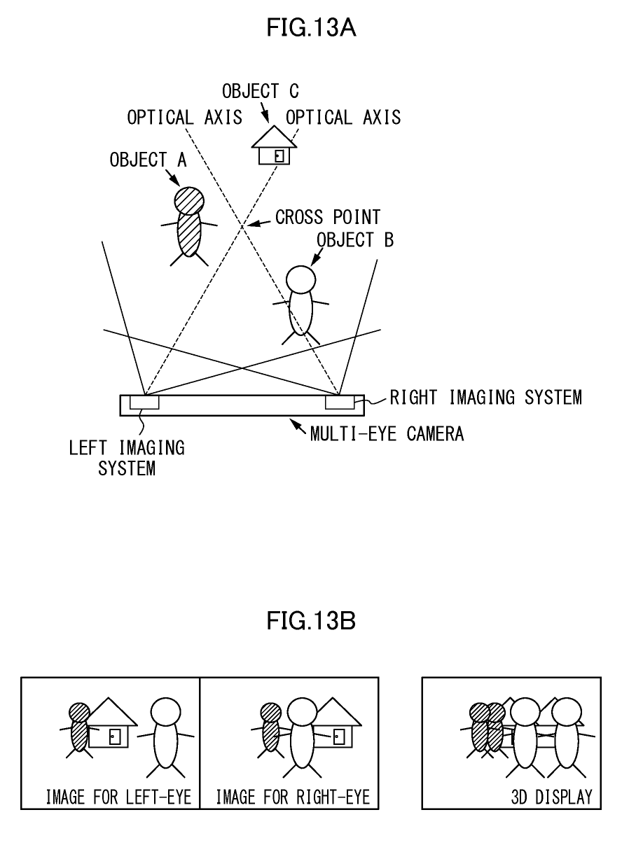

FIG. 11H is a drawing explaining the 2D processing of the multi-eye digital camera 3 (No. 8).

FIG. 11I is a drawing explaining the 2D processing of the multi-eye digital camera 3 (No. 9).

FIG. 11J is a drawing explaining the 2D processing of the multi-eye digital camera 3 (No. 10).

FIG. 11K is a drawing explaining the 2D processing of the multi-eye digital camera 3 (No. 11).

FIG. 12 is a drawing showing a variation of the 2D processing of the multi-eye digital camera 3.

FIG. 13A is a drawing showing a positional relation between the camera and the object.

FIG. 13B is a drawing of an image for right-eye, an image for left-eye, and a three-dimensional image photographed in the positional relation shown in FIG. 13A.

### DETAILED DESCRIPTION OF THE EMBODIMENTS

Hereinafter, description will be provided on the best mode for carrying out the three-dimensional image display device, the three-dimensional image display method, the three-dimensional image display program, and the recording medium according to the present invention with reference to the accompanying drawings.

### First Embodiment

FIG. 1A and FIG. 1B are schematic views of a multi-eye digital camera 1 equipped with the three-dimensional image device according to the present invention. FIG. 1A is a front elevation view thereof and FIG. 1B is a back elevation view thereof. The multi-eye digital camera 1 is equipped with multiple (two in the example of FIG. 1A and FIG. 1B) imaging systems, and can photograph a three dimensional image (stereoscopic image) showing an identical object viewed from multiple viewpoints (two viewpoints on the right and left in the example of FIGS. 1A and 1B), and a single viewpoint image (two-dimensional image). The multi-eye digital camera 1 can record and reproduce not only still images, but also moving images and sounds.

A camera body 10 of the multi-eye digital camera 1 has a substantially rectangular parallelepiped box shape, and a barrier 11, a right imaging system 12, a left imaging system 13, a flash 14, and a microphone 15 are chiefly disposed on the front face of the camera body 10, as shown in FIG. 1A. A release switch 20 and a zoom button 21 are chiefly disposed on the top face of the camera body 10.

On the back face of the camera body 10, there are disposed a monitor 16, a mode button 22, a parallax adjusting button 23, a 2D-3D switching button 24, a MENU-OK button 25, a cross button 26, and a DISP-BACK button 27, as shown in FIG. 1B.

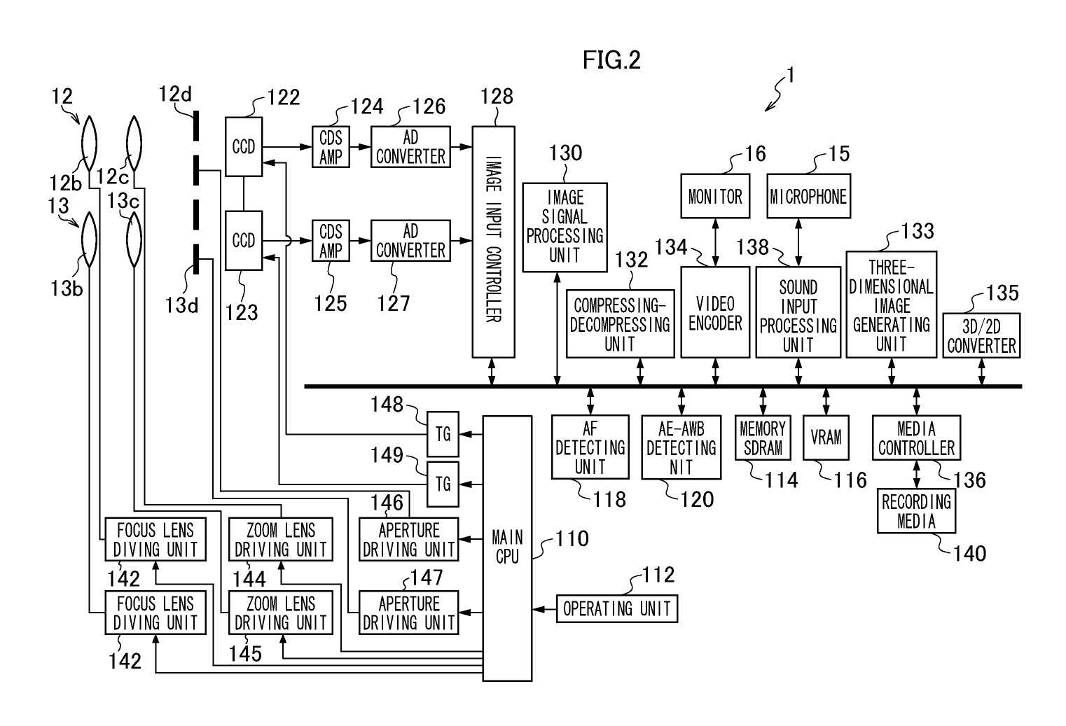

The barrier 11 is slidingly (slidably) attached on the front face of the camera body 10, and the barrier 11 vertically slides so as to change over the open state and the closed state. Normally, as indicated by the dotted lines in FIG. 1A, the barrier 11 is located at the upper end, that is, in the closed state, so that objective lenses 12a, 13a and so on are covered by the barrier 11. Accordingly, the lenses are prevented from being damaged. When the barrier slides to be positioned at the lower end, that is, in the open state (see the solid lines FIG. 1A), the lenses at the front face of the camera body 10 and other components are exposed. If a sensor (not shown) recognizes that the barrier 11 is in the open state, a CPU 110 (see FIG. 2) turns on the power so as to put the multi-eye digital camera 1 into a photographable state.

The right imaging system 12 for picking up an image for the right eye, and the left imaging system 13 for picking up an image for the left eye are optical units that include photographing lens groups having folded optics, aperture-mechanical shutters 12d, 13d, and image sensors 122,123 (see FIG. 2). The respective photographing lens groups of the right imaging system 12 and the left imaging system 13 mainly include the objective lenses 12a, 13a for picking up lights from the object, prisms (not shown) for bending a light path entering from each objective lens at a substantially right angle, zoom lenses 12c, 13c (see FIG. 2), and focus lenses 12b, 13b (see FIG. 2), and others.

The flash 14 includes a xenon tube, and is fired when a dark object or an object against a backlight is photographed if necessary.

The monitor 16 is a liquid crystal monitor having a typical aspect ratio of 4:3 and a color-display function, and can display a three-dimensional image as well as a plan image. The detailed structure of the monitor 16 is not shown in the drawing, but the monitor 16 is a parallax barrier type 3D monitor equipped with a parallax barrier display layer on its surface. The monitor 16 is used as a user interface display panel when a user operates various settings, and is also used as an electronic viewfinder at the time of photographing an image.

The monitor 16 can be changed over between a three-dimensional image display mode (3D mode) and a plan image display mode (2D mode). In the 3D mode, a parallax barrier constituted by patterns of light transparent sections and light shielding sections arranged alternatively with predetermined intervals is generated on the parallax barrier layer of the monitor 16, and the strip image pieces showing the right and left images arranged alternatively are displayed on the image display plane under this parallax barrier layer. In the D2 mode or when used as the user interface display panel, nothing is displayed on the parallax barrier display layer, and an image is display as it is on the image display plane under the parallax barrier display layer.

Instead of employing the parallax barrier system in the monitor 16, a lenticular system, an integral photography system using a microlens array sheet, and a holography system using an interference phenomenon may also be employed in the monitor 16. The monitor 16 is not limited to a liquid crystal monitor, an organic EL, and so on may be employed in the monitor 16.

The release switch 20 is a two stroke switch including a so-called “half press” and “full press”. When a still image is photographed (when the still image photographing mode is selected by the mode button 22, or by selecting the menu, for example), the multi-eye digital camera 1 executes various operations of the photographing preparation, i.e. AE(automatic exposure), AF(auto focus), and AWB (automatic white balance) through the half press of the release switch 20, and the multi-eye digital camera 1 executes the photographing and recording operation of an image through the full press of the switch 20. During the photographing of moving images (when the moving-image photographing mode is selected by the mode button 22, or by selecting the menu, for example), if the release switch 20 is fully pressed, the multi-eye digital camera 1 starts photographing the moving images, and if the release switch 20 is fully pressed once again, the photographing is ended.

The zoom button 21 is used in the zooming operation of the right imaging system 12 and the left imaging system 13, and includes a zoom telephoto button 21T for instructing a zooming-in, and a zoom wide button 21W for instructing a zooming-wide.

The mode button 22 functions as a photographing-mode setting unit for setting a photographing mode of the digital camera 1, and the photographing mode of the digital camera 1 can be set to various modes according to the positions of setting the mode button 22. The photographing mode is classified into the “moving image photographing mode” for photographing moving images, and the “still image photographing mode” for photographing still images. The still image photographing mode” includes, for example, an “automatic photographing mode” in which the digital camera 1 automatically sets and aperture, a shutter speed and others, a “face-extraction photographing mode” for extracting and photographing a human face, a “sport photographing mode” suitable for photographing a moving body, a “landscape photographing mode” suitable for photographing a landscape, a “night-view photographing mode” suitable for photographing sunset and night views, an “aperture-priority photographing mode” in which the user sets the scale of the aperture, and the digital camera 1 automatically sets the shutter speed, a “shutter-speed-priority photographing mode” in which the user sets the shutter speed, and the digital camera 1 automatically sets the scale of the aperture, and a “manual photographing mode” in which the user sets the aperture, the shutter speed and others.

The parallax adjusting button 23 is a button for adjusting the parallax at the time of photographing a three-dimensional image. Pressing the right side of the parallax adjusting button 23 increases the parallax between an image photographed on the right imaging system 12 and an image photographed on the left imaging system 13 by a predetermined distance, and pressing the left side of the parallax adjusting button 23 decreases the parallax between the image photographed on the right imaging system 12 and the image photographed on the left imaging system 13 by a predetermined distance.

The 2D-3D switching button 24 is a switch for instructing a changeover between the 2D photographing mode for photographing a single viewpoint image and the 3D photographing mode for photographing a multi-viewpoint image.

The MENU-OK button 25 is used not only for calling various setting screens (menu screen) of the photographing and reproducing functions (MENU function), but also for deciding the selection, and instructing the execution of a selected operation (OK function); and thus every adjusting item included in the multi-eye digital camera 1 can be set by the MENU-OK button 25. Pressing the MENU-OK button 25 during the photographing allows the monitor 16 to display setting screens for setting the image quality adjustment such as a exposure value, contrast, ISO speed, and the number of recorded pixels, and pressing the MENU-OK button 25 during the reproducing allows the monitor 16 to display the setting screens for deleting the image, or the like. The multi-eye digital camera 1 operates in accordance with a condition set on this menu screen.

The cross button 26 is used for executing the setting or selecting the various menus, or used for zooming, and the cross button 26 can be pressed in the right and left directions, and also in the upward and downward directions, that is, in the four directions, and a function in accordance with the setting condition of the camera is assigned to each key in each direction. For example, during the photographing operation, a ON-OFF switching function of a macro function is assigned to the left key, and a function to change over the flash mode is assigned to the right key. A function to change the brightness of the monitor 16 is assigned to the upper key, and a function to change over ON-OFF and time of a self-timer is assigned to the lower key. During the reproducing operation, a frame advance function is assigned to the right key, and a frame return function is assigned to the left key. A function to delete an image under reproduction is assigned to the upper key. In the various setting operations, such a function is provided that shifts a cursor displayed on the monitor 16 in each key direction.

The DISP-BACK button 27 functions as a button for instructing changeover of the display of the monitor 16, and if the DISP-BACK button 27 is pressed during the photographing operation, the display on the monitor 16 is changed over in the following order: ON→framing guide display→OFF. The DISP-BACK button 27 is pressed during the reproducing operation, the display on the monitor 16 is changed over in the following order: normal play→no subtitle play→multi-play. The DISP-BACK button 27 functions for instructing a cancel of an input operation or return to a previous operational state.

FIG. 2 is a block diagram showing the major internal configuration of the multi-eye digital camera 1. The multi-eye digital camera 1 chiefly includes a CPU (central processing unit) 110, an operating unit (release switch 20, MENU-OK button 25, cross button 26, etc.) 112, an SDRAM (synchronous dynamic random access memory) 114, a VRAM (video random access memory) 116, an AF detecting unit 118, an AE-AWB detecting unit 120, the image sensors 122,123, CDS-AMPs (correlated double sampler-amplifier) 124,125, AD converters 126,127, an image input controller 128, an image signal processing unit 130, a compressing-decompressing unit 132, a three-dimensional image generating unit 133, a video encoder 134, a 3D/2D converter 135, a media controller 136, a sound input processing unit 138, a recording media 140, focus lens driving units 142,143, zoom lens driving units 144,145, aperture driving units 146,147, and timing generators (TG) 148,149.

The CPU 110 comprehensively controls the overall operation of the multi-eye digital camera 1. The CPU 110 controls the operations of the right imaging system 12 and the left imaging system 13. The right imaging system 12 and the left imaging system 13 basically operate in association with each other, and they may operate separately. The CPU 110 generates display image data by dividing each of two image data acquired on the right imaging system 12 and the left imaging system 13 into strip image pieces, and displaying these strip image pieces for the right eye and the left eye so as to be alternatively arranged on the monitor 16. When performing the display in the 3D mode, the CPU 110 generates the parallax barrier constituted by patterns in which the light transparent sections and the light shielding sections alternatively arranged with the predetermined intervals on the parallax barrier display layer, and the strip image pieces for the right eye and the left eye alternatively arranged on the image display plane under this parallax barrier layer; accordingly thereby attaining a haploscopic vision.

The SDRAM 114 stores firmware that are control programs executed by the CPU 110, various data required for the controls, setting values of the camera, image data regarding photographed images, and others.

The VRAM 116 is used as the operational area of the CPU 110 as well as the temporary storage area of the image data.

The AF detecting unit 118 calculates physical quantities required for the AF control based on the input image signals in accordance with an instruction from CPU 110. The AF detecting unit 118 includes a right imaging system AF controlling circuit for executing the AF control based on the image signal input from the right imaging system 12, and a left imaging system AF controlling circuit for executing the AF control based on the image signal input from the left imaging system 13. In the digital camera 1 of the present embodiment, the AF control is executed based on the contrast of the images acquired from the image sensors 122,123 (so-called contrast AF), and the AF detecting unit 118 calculates a focus evaluation value indicating the sharpness of the image based on the input image signal. The CPU 110 detects a position at which the focus evaluation value is local maximum among the focus evaluation values calculated on the AF detecting unit 118, and moves the focus lens group to this position. Specifically, the CPU 110 moves the focus lens group from the closest distance to the infinite distance in accordance with the predetermined steps, acquires a focus evaluation value at every point, and determines as the focus position a position at which the focus evaluation value is maximum among the obtained focus evaluation values, and then moves the focus lens group to this position.

The AE-AWB detecting unit 120 calculates physical quantities required for the AF control and the AWB control based on the input image signals in accordance with an instruction from CPU 110. For example, as the physical quantities required for the AE control, one screen is divided into plural areas (16×16, for example), and an integrated value of image signals of R, G, B is calculated for each divided area. Based on the integrated values obtained on the AE-AWB detecting unit 120, the CPU 110 detects the brightness of the object (object brightness), and calculates an exposure value (photographing EV value) suitable to the photographing. The CPU 110 also determines the aperture value and the shutter speed based on the calculated photographing EV value and the predetermined program diagram. As the physical quantities required for the AWB control, one screen is divided into plural areas (16×16, for example), and an average integrated value for each color of image signals of R, G, B is calculated for each divided area. Based on the integrated value of R, the integrated value of B, and the integrated value of G that are obtained, the CPU 110 calculates ratios of R/G and B/G for each divided area, and determines the type of the light source based on the distributions of the found R/G values and the found B/G values in the color spaces of R/G and B/G. In accordance with the white balance adjusting value suitable to the determined type of the light source, the CPU 110 determines gain values (white balance correction values) for the R, G, B signals of the white balance adjusting circuit such that the each ratio value becomes approximately 1 (i.e., the integrated ratio of RGB in one screen becomes R:G:B≈1:1:1).

Each of the image sensors 122,123 includes a color CCD quipped with color filters of R, G, B in a predetermined color filter array (such as a honeycomb array and a Bayer array). Each of the image sensors 122,123 receives a light of the object imaged by the focus lenses 12b, 13b, the zoom lenses 12c, 13c and the like, and the incident light in the light receiving surface is converted by each photodiode into a signal charge in accordance with the incident light volume. Regarding the accumulation operation of light electric charge and transfer operation of the image sensors 122,123, the electronic shutter speed (light charge accumulation time) is determined based on the charge drain pulses input from the respective TGs 148,149.

Specifically, while the light drain pulses are input into the image sensors 122,123, charges are drained without being stored in the image sensors 122,123. On the other hand, if no light drain pulse is input into the image sensors 122,123, no charge is drained, so that charge accumulation, that is, the exposure is started on the image sensors 122,123. The imaging signals acquired on the image sensors 122,123 are output to the CDS-AMPs 124,125 based on the driving pulses given from the respective TGs 148,149.

A correlative double sampling processing is carried out on the image signals output from the image sensors 122,123 (processing to obtain accurate pixel data by finding a difference between a field through component level and a pixel signal component level contained in an output signal for each pixel of each image sensor, so as to reduce noises (particularly, thermal noises) contained in the output signals of each image sensor), and the resulted signals are amplified so as to generate analogue image signals for R, G, B by the CDS-AMPs 124,125.

The AD converters 126,127 convert the analogue image signals of R, G, B generated on the CDS-AMPs 124,125 into digital image signals.

The image input controller 128 includes a line buffer having a predetermined capacity, and accumulates image signals for a single image output from the CDS-AMP-AD converter, and records the signals on the VRAM 116 in accordance with an instruction from the CPU 110.

The image signal processing unit 130 includes a simultaneous circuit (processing circuit of interpolating a special deviation of a color signal due to the color filter array of a single board CCD, and converting the color signal into a simultaneous signal), a white balance correction circuit, a gamma correction circuit, a contour correction circuit, a brightness-color difference generating circuit, and others, and the image signal processing unit 130 performs an appropriate signal processing to the input image signal in accordance with an instruction from the CPU 110, so as to generate image data (YUV data) including brightness data (Y data) and color difference data (Cr, Cb data). Hereinafter, image data generated from the image signals output from the image sensor 122 is referred to as image for right-eye data (image for right-eye, hereinafter), and image data generated from the image signals output from the image sensor 123 is referred to as image for left-eye data (image for left-eye, hereinafter).

The compressing-decompressing unit 132 performs a compression processing using a predetermined format to the input image data in accordance with an instruction from the CPU 110, so as to generate compressed image data. The compressing-decompressing unit 132 performs a decompression processing using a predetermined format to the input compressed image data in accordance with an instruction from the CPU 110, so as to generate uncompressed image data.

The three-dimensional image generating unit 133 processes the image for right-eye and the image for left-eye so that these images can be three-dimensionally displayed on the monitor 16. For example, if the monitor employs the parallax barrier system, the three-dimensional image generating unit 133 generates the display image data by dividing the image for right-eye and the image for left-eye that are to be reproduced into strip image pieces, and alternatively arranges these strip image pieces for the right eye and the left eye. The display image data is output from the three-dimensional image generating unit 133 through the video encoder 134 to the monitor 16.

The video encoder 134 controls the display on the monitor 16. Specifically, the video encoder 134 converts the display image data and others generated on the three-dimensional image generating unit 133 into video signals (such as NTSC (National Television System Committee) signals, PAL (Phase Alternation by Line) signals, SECAM (Sequential Couleur A Memorie) signals), and outputs these signals to the monitor 16, so as to display the display image data on the monitor 16, and also outputs information regarding predetermined characters and figures to the monitor 16, if necessary. Accordingly, the image for right-eye and the image for left-eye are three-dimensionally displayed on the monitor 16.

In the present embodiment, an object unfavorable for a haploscopic vision (referred to as a target object, hereinafter) is extracted based on pop-out amount of the object when the image for right-eye and the image for left-eye are displayed on the monitor 16, and the image for right-eye and the image for left-eye are processed so as to prevent the target object from being three-dimensionally viewed or hinder the target object from being three-dimensionally viewed (referred to as a 2D processing, hereinafter). This image processing is executed on the 3D/2D converter 135. The 3D/2D converter 135 will be described as follows.

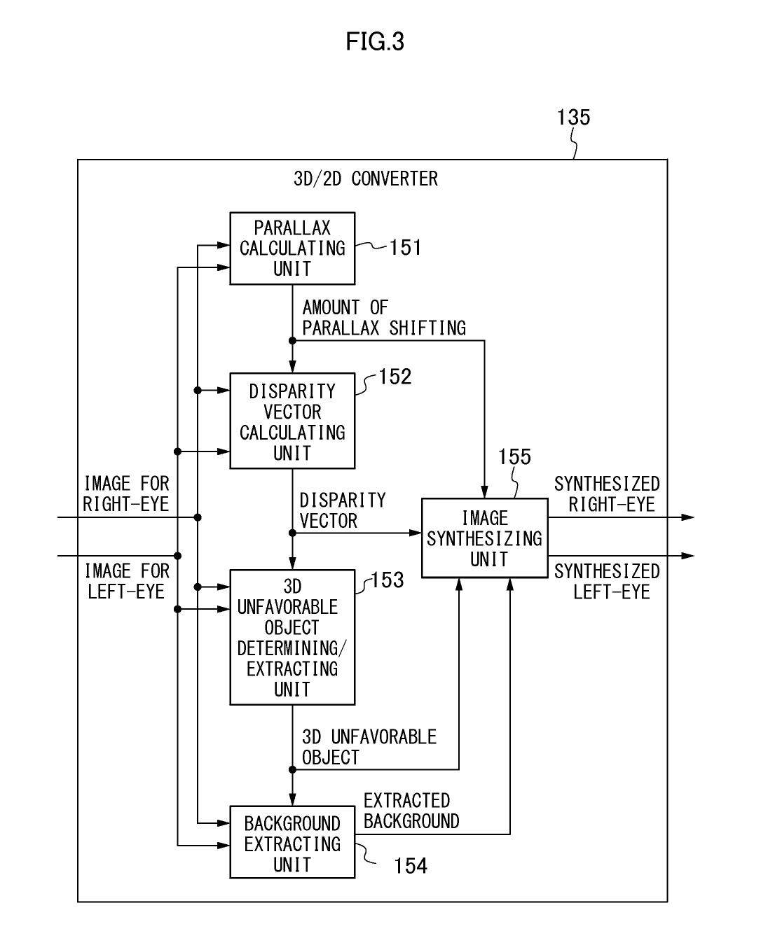

FIG. 3 is a block diagram showing the internal configuration of the 3D/2D converter 135. The 3D/2D converter 135 mainly includes a parallax calculating unit 151, a disparity vector calculating unit 152, an 3D unfavorable object determining/extracting unit 153, a background extracting unit 154, and an image synthesizing unit 155.

The parallax calculating unit 151 extracts main objects from the image for right-eye and from the image for left-eye, and calculates each amount of parallax of the extracted main objects (i.e., difference between the current parallax and the parallax of 0 in a main object of interest). The main objects can be defined in various methods, based on the persons recognized on a face detecting unit (not shown), on the focused objects, or on the objects selected by the user.

Each amount of parallax has a magnitude and an direction, and the direction has two directions, one of which is used for shifting the main object backward (in the present embodiment, the direction for shifting the image for right-eye to the right), and the other of which is used for shifting the main object frontward (in the present embodiment, the direction for shifting the image for right-eye to the left). The direction for shifting the main object backward may be a direction for shifting the image for left-eye to the left, and the direction for shifting the main object frontward may be a direction for shifting the image for left-eye to the right; in the present embodiment, however, the image for left-eye is defined as the reference image, as described later, and thus the image for right-eye is shifted to the right or to the left.

The amount of parallax calculated on the parallax calculating unit 151 is input into the disparity vector (displacement vector) calculating unit 152 and the image synthesizing unit 155.

Based on the amount of parallax calculated on the parallax calculating unit 151, the disparity vector calculating unit 152 executes a parallax shifting on the image for right-eye by its amount of parallax, so as to allow the position of the main object in the image for right-eye to correspond with the position of the main object in the image for left-eye. The disparity vector calculating unit 152, then, calculates a disparity vector for each object based on the image for right-eye and the image for left-eye after the parallax shifting is executed.

The disparity vector is calculated on the disparity vector calculating unit 152 as follows. (1) Extracting all the objects from the image for right-eye and the image for left-eye after the parallax shifting is executed. (2) Extracting a feature point of the object of interest from one of the image for right-eye and the image for left-eye (referred to as the reference image, hereinafter), and detecting a point corresponding to the feature point in an image other than the reference image (referred to as a secondary image, hereinafter) of the image for right-eye and the image for left-eye. (3) Calculating the degree of deviation of the corresponding point in the secondary image relative to the feature point in the reference image as a disparity vector of the object of interest having a magnitude and a direction. It is assumed in the present embodiment that the image for left-eye is a reference image. (4) Repetitively performing the steps of (2) and (3) to every extracted object to the entire object extracted in (1). Through these steps, the disparity vector is calculated for every object. The disparity vectors calculated on the disparity vector calculating unit 152 are input into the 3D unfavorable object determining/extracting unit 153 and the image synthesizing unit 155.

The 3D unfavorable object determining/extracting unit 153 extracts a target object based on the disparity vectors input from the disparity vector calculating unit 152. In the present embodiment, such an object that has a disparity vector whose direction is leftward, that is, is located more frontward than the cross point (having a parallax in the direction of popping out from the screen plane), and whose disparity vector is equal to or more than a threshold value is extracted as the target object. In such a manner, the object whose parallax in the direction of popping out from the screen plane is equal to or more than a predetermined value can be extracted as the target object.

This threshold value varies depending on the size of the monitor 16, the distance between the user and the monitor 16, or the like. Therefore, the threshold value is predefined in accordance with the specifications of the monitor 16, and this value is stored on a memory area (not shown) of the 3D unfavorable object determining/extracting unit 153. This threshold value may be set by the user through the operating unit 112. Information regarding the target object extracted on the 3D unfavorable object determining/extracting unit 153 is input into the background extracting unit 154 and the image synthesizing unit 155.

This predetermined threshold value may be changed based on the size of the target object. The corresponding relation between sizes of the target object and threshold values may be stored on the memory area (not shown) in the 3D unfavorable object determining/extracting unit 153, and the threshold value to be used is determined depending on the size of the target object extracted on the disparity vector calculating unit 152.

The background extracting unit 154 extracts a background of target object in the image for right-eye (referred to as a background image of the right-eye mage, hereinafter) from the image for left-eye. The background image for the image for right-eye extracted from the image for left-eye is input into the image synthesizing unit 155. The processing on the background extracting unit 154 will be described in detail later.

Based on the disparity vector input from the disparity vector calculating unit 152 and the information regarding the target object input from the 3D unfavorable object determining/extracting unit 153, the image synthesizing unit 155 synthesizes the image of the target object (referred to as a target object image, hereinafter) in the image for left-eye, so as to overlappingly (in a superimposed manner) display the target object images in the image for left-eye. The synthesizing position in the image for left-eye is (corresponds with) the position where the target object is located in the image for right-eye. Based on the information regarding the target object input from the 3D unfavorable object determining/extracting unit 153 and the background image for the image for right-eye input from the background extracting unit 154, the image synthesizing unit 155 synthesizes the background image for the image for right-eye in the image for right-eye so as to delete the target object image from the image for right-eye. Detailed description will be provided on processing of the image synthesizing unit 155 later.

The image for right-eye and the image for left-eye generated in this manner are output to the appropriate blocks such as the three-dimensional image generating unit 133 as an output from the 3D/2D converter 135. Using the same method as described above, the image for right-eye and the image for left-eye output from the 3D/2D converter 135 are processed by the three-dimensional image generating unit 133 so as to be three-dimensionally displayed on the monitor 16, and be output to the monitor 16 through the video encoder 134. Accordingly, the image for right-eye and the image for left-eye processed on the 3D/2D converter 135 are three-dimensionally displayed on the monitor 16.

With reference to FIG. 2 once again, the media controller 136 records each of the image data that are compressed on the compressing-decompressing unit 132 in the recording media 140.

The sound input processing unit 138 receives audio signals input into the microphone 15 and amplified on a stereo microphone amplifier (not shown), and encodes the input audio signals.

The recording media 140 may include various recording media such as an xD Picture Card (registered trademark) detachably mounted in the multi-eye digital camera 1, a semiconductor memory card represented by a Smart Media (registered trademark), a portable compact hard disk, a magnetic disk, an optical disk, and a magneto-optical disk, etc.

In accordance with an instruction from the CPU 110, the focus lens driving units 142,143 move the respective focus lenses 12b, 13b in their optical axis directions, so as to vary their focal points.

In accordance with an instruction from the CPU 110, the zoom lens driving units 144,145 move the respective zoom lenses 12c, 13c in their optical axis directions, so as to vary their focal distances.

The aperture-mechanical shutters 12d, 13d are driven by respective iris motors of the respective aperture driving units 146, 147, so as to vary their aperture, thereby adjusting the incident light amount into the image sensor 123.

In accordance with an instruction from the CPU 110, the aperture driving units 146, 147 vary the respective apertures of the aperture-mechanical shutters 12d, 13d, thereby adjusting the incident light into the image sensor 123. In addition, in accordance with an instruction from the CPU 110, the aperture driving units 146, 147 open or close the respective aperture-mechanical shutters 12d, 13d, thereby performing the exposure and light shielding operation to the respective image sensors 122, 123.

The operations of the multi-eye digital camera 1 having the abovementioned configuration will now be described as follows.

(A) Photographing mode

If the barrier 11 is slid from the closed state to the open state, the multi-eye digital camera 1 is powered on, so that the multi-eye digital camera 1 is activated in the photographing mode. The photographing mode can be changed over between the 2D mode and the 3D photographing mode for photographing a three-dimensional image of an identical object viewed from two viewpoints. The 3D mode can be set to the 3D photographing mode for photographing a three-dimensional image with a predetermined parallax at the same time using the right imaging system 12 and the left imaging system 13. The setting of the photographing mode can be executed by pressing the MENU-OK button 25 while the multi-eye digital camera 1 is in operation in the photographing mode, and in the displayed menu screen, the “photographing mode” is selected by using the cross button 26, thereby enabling the photographing mode to be set through the photographing mode menu screen displayed on the monitor 16.

(1) 2D photographing mode

The CPU 110 selects the right imaging system 12 or the left imaging system 13 (the left imaging system 13 in the present embodiment), and starts photographing a photographing confirmation image on the image sensor 123 of the selected left imaging system 13. Specifically, images are photographed in succession on the image sensor 123, and the image signals thereof are processed in succession, thereby generating image data for the photographing confirmation image.

The CPU 110 sets the monitor 16 to the 2D mode, sequentially inputs the generated image data to the video encoder 134 so as to convert the image data into a signal form for display, and then outputs the signals to the monitor 16. Through this operation, the image picked up on the image sensor 123 is three-dimensionally displayed on the monitor 16. If the monitor 16 can accept digital signals, the video encoder 134 is unnecessary, and the data should be converted into the signal form compliant with the input specifications of the monitor 16.

The user makes a framing, confirms the object to be photographed, confirms an image after photographed, or defines the photographing condition while monitoring the photographing confirmation image three-dimensionally displayed on the monitor 16.

If the release switch 20 is half-pressed during the photographing stand-by state, the S1ON signal is input into the CPU 110. The CPU 110 detects this signal, and then executes the AE photometry and the AF control. During executing the AE photometry, the brightness of the object is measured based on the integrated value or the like of the image signals picked up through the image sensor 123, or the like. The value of the measured light (photometric value) is used for determining the aperture value of the aperture-mechanical shutter 13d and the shutter speed. At the same time, it is determined whether or not the flash 14 should be used based on the detected brightness of the object. If it is determined that the flash 14 should be used, a pre-flash is fired on the flash 14, and then the flash intensity for an actual photographing is determined based on the reflected light of the pre-flash.

If the release switch 20 is fully pressed, the S2ON signal is input into the CPU 110. In response to this S2ON signal, the CPU 110 executes the photographing and recording processing.

The CPU 110 drives the aperture-mechanical shutter 13d through the aperture driving unit 147 in accordance with the aperture value defined based on the photometrical value, and also adjusts the charge accumulation time (so-called electronic shutter) for the image sensor 123 so as to attain the shutter speed defined based on the photometric value.

The CPU 110 shifts the focus lens from a lens position corresponding to the closest distance to a lens position corresponding to the infinite distance by turns during executing the AF control, acquires from the AF detecting unit 118 evaluation values obtained by integrating high frequency components of the image signals based on the image signals in the AF areas of the images that are picked up at every lens position through the image sensor 123, finds a lens position where the maximum of the evaluation values exists, and shifts the focus lens to this lens position so as to perform contrast AF.

At this time, if the flash 14 is used, flash 14 is fired based on the flash intensity of the flash 14 defined based on the pre-flash.

The light of the object enters the light receiving surface of the image sensor 123 through the focus lens 13b, the zoom lens 13c, the aperture-mechanical shutter 13d, an infrared cut filter 46, an optical low pass filter 48, and others.

The signal charge accumulated on each photo diode of the image sensor 123 is read out in accordance with a timing signal provided from the TG 149, is output from the image sensor 123 as the voltage signal (image signal) by turns, and then is input into the CDS-AMP 125.

The CDS-AMP 125 performs the correlative double sampling processing on the CCD output signals based on the CDS pulse, and amplifies the image signals output from a CDS circuit with a photography sensitivity setting gain provided from the CPU 110.

The analogue image signals output from the CDS-AMP 125 are converted on the AD converter 127 into digital image signals, and the converted digital signals (RAW data of R, G, B) are transferred to the SDRAM 114, and are stored there temporarily.

The image signals of R, G, B read out from the SDRAM 114 are input into the image signal processing unit 130. The image signal processing unit 130 performs the white balance adjustment by applying a digital gain to each image signal of R, G, B through a white balance adjusting circuit, performs a gradation conversion processing onto each image signal of R, G, B in accordance with the gamma characteristics through a gamma correction circuit, and performs through the simultaneous circuit a simultaneous processing to interpolate a special deviation of each color signal due to the color filter array of a single board CCD, thereby matching the phase of each color signal with one another. The simultaneous image signals of R, G, B are converted into a bright signal Y and color difference signals Cr, Cb (YC signal) through the brightness-color difference data generating circuit, where a predetermined signal processing such as edge enhancement is applied to the image signals. The YC signal processed on the image signal processing unit 130 is accumulated on the SDRAM 114.

The YC signals accumulated on the SDRAM 114 in the abovementioned manner are compressed on the compressing-decompressing unit 132, and are stored on the recording media 140 through the media controller 136 as an image file in a predetermined format. The still image data is stored on the recording media 140 as an image file compliant with the Exif standard (exchangeable image file format specification: a format of image meta data standardized by Japanese Electronic Industry Development Association). The Exif file includes an area for storing data of the main image, and an area for storing data of the reduced image (thumbnail images). The thumbnail image in a specified size (for example, 160×120 pixels, 80×60 pixels and so on), for example, is generated by applying a pixel thinning-out processing and other necessary data processing to the data of the main image acquired by the photographing. The thumbnail image generated in such a manner is written along with the main image in the Exif file. Tag information such as a photographing date, a photographing condition, face detecting information, and others is attached to the Exif file.

If the mode of the multi-eye digital camera 1 is set to the reproduction mode, the CPU 110 outputs a command to the media controller 136 so as to instruct the recording media 140 to read out the latest recorded image file.

The compressed image data of the image file that is read out is provided for the compressing-decompressing unit 132, so as to be decompressed into uncompressed brightness-color difference signals, and is processed into a three-dimensional image on the three-dimensional image generating unit 133, and thereafter is output to the monitor 16 through the video encoder 134. The image recorded on the recording media 140 is reproduced and displayed on the monitor 16 (reproduced as a single image). The image photographed in the 2D mode is displayed on the entire screen of the monitor 16 as a planar image in the 2D mode.

The frame advance of the image is executed by using the right and the left keys of the cross button 26, and if the right key of the cross button 26 is pressed, a next image file is read out from the recording media 140, and is reproduced and display on the monitor 16. If the left key of the cross button 26 is pressed, a previous image file is read out from the recording media 140, and is reproduced and display on the monitor 16.

While monitoring the images reproduced and displayed on the monitor 16, the images recorded on the recording media 140 can be erased if necessary. The image erasing is executed by pressing the MENU-OK button 25 while the image is reproduced and displayed on the monitor 16.

(2) During 3D photographing mode

Photographing of the photographing confirmation image is started on the image sensor 122 and the image sensor 123. Specifically, the identical object is photographed in succession on the image sensor 122 and the image sensor 123, and their image signals are processed in succession, so as to generate three-dimensional image data for the photographing confirmation image. The CPU 110 sets the monitor 16 in the 3D mode, and the generated image data is converted on the video encoder 134 by turn into data in a signal form for display, and then is output to the monitor 16. In this way, the three-dimensional image data for the photographing confirmation image is three-dimensionally displayed on the monitor 16.

While monitoring the photographing confirmation image three-dimensionally displayed on the monitor 16, the user makes a framing, confirms the object to be photographed, confirms the image after photographed, or sets the photographing condition.

If the release switch 20 is half-pressed during the photographing stand-by state, the S1ON signal is input into the CPU 110. The CPU 110 detects this signal, and then executes the AE photometry and the AF control. The AE photometry is carried out on one of the right imaging system 12 and the left imaging system 13 (left imaging system 13 in the present embodiment). The AF control is carried out in each of the right imaging system 12 and the left imaging system 13. The AE photometry and the AF control are the same as those in the 2D mode; therefore, detailed description thereof will be omitted.

If the release switch 20 is fully pressed, the S2ON signal is input into the CPU 110. In response to this S2ON signal, the CPU 110 executes the photographing and recording processing. The process of generating the image data photographed respectively on the right imaging system 12 and the left imaging system 13 is the same as that in the 2D photographing mode; therefore, detailed description thereof will be omitted.

From the two image data generated respectively on the CDS-AMPs 124,125, two compressed image data are generated in the same manner as that in the 2D photographing mode. The two compressed image data are associated with each other as a single file, and this file is stored on a storage media 137. The MP format may be used as the storage format.

(B) Reproduction mode

If the multi-eye digital camera 1 is set in the reproduction mode, CPU 110 outputs a command to the media controller 136, so as to instruct the recording media 140 to read out the latest recorded file. The compressed image data of the image file that is read out is provided for the compressing-decompressing unit 132, so as to be decompressed into a uncompressed brightness-color difference signal, and the 2D processing is applied to the target object on the 3D/2D converter 135.

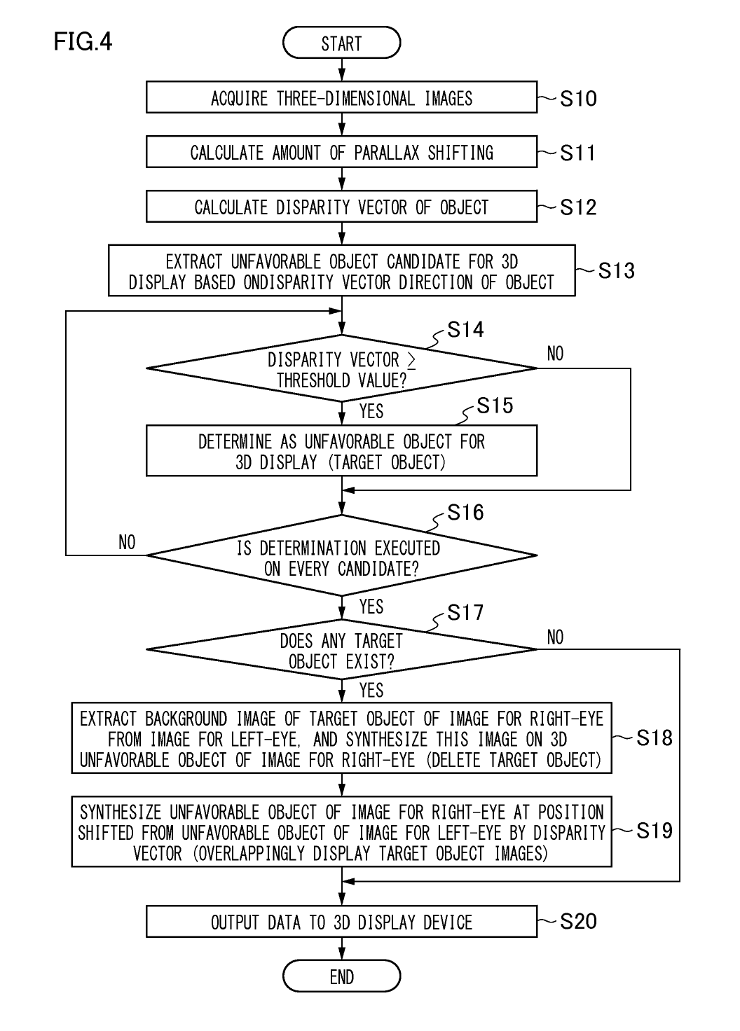

FIG. 4 is a flow chart showing a flow of the 2D processing for the target object on the 3D/2D converter 135.

In step S10, the image data decompressed into the uncompressed brightness/color difference signal on the compressing-decompressing unit 132, that is, the image for right-eye and the image for left-eye are input into the 3D/2D converter 135.

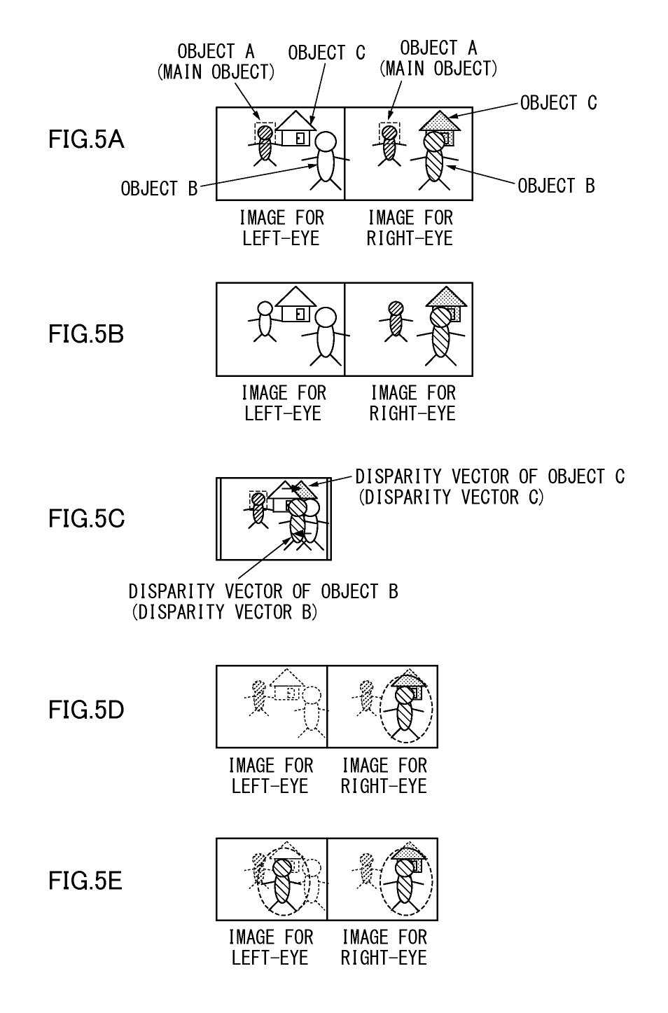

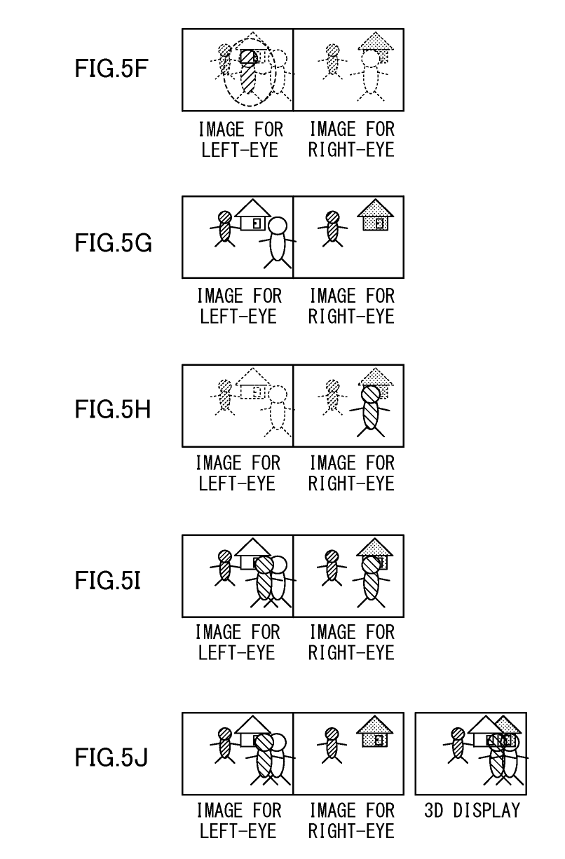

In step S11, the parallax calculating unit 151 acquires the image for right-eye and the image for left-eye, and extracts the main object from the image for right-eye and from the image for left-eye, and then calculates the amount of the parallax of the main object. As shown in FIG. 5A, if an object A is the main object, the parallax calculating unit 151 compares the position of the object A in the image for left-eye to the position of the object A in the image for right-eye, so as to calculate the amount of the parallax of the object A. In the case of FIG. 5A, the position of the object A in the image for right-eye is deviated (shifted) leftward by “a” from the position of the object A in the image for left-eye; thus it is calculated that the amount of the parallax has a magnitude of “a” and a direction for shifting the image for right-eye to the right. In FIG. 5A to FIG. 5J, the object B and the object C are shaded in the image for left-eye so that the object B and the object C in the image for left-eye can be distinguished from the object B and the object C in the image for right-eye for a clear explanation. It is not meant that the object B and the object C in the image for right-eye are different from the object B and the object C in the image for left-eye.

In step S12, the amount of the parallax calculated in the step S11 is input into the vector calculating unit 152. As shown in FIG. 5B, the disparity vector calculating unit 152 executes the parallax shifting to shift the image for right-eye by the amount of the parallax (magnitude of “a” in the rightward direction in the case of FIG. 5B), and the disparity vector calculating unit 152 calculates a disparity vector for each object based on the image for right-eye after the parallax shifting and on the image for left-eye. In the example shown in FIG. 5A to FIG. 5J, the disparity vector of the object A is 0 through the parallax shifting; therefore, the disparity vectors are calculated for the objects B and C.

FIG. 5C is a drawing of overlapping the image for left-eye with the image for right-eye shown in FIG. 5B. Through the parallax shifting, the object located more frontward than the main object has a direction of the disparity vector reverse to a direction of the disparity vector of the object located more backward than the main object. As shown in FIG. 5C, since the object B is located more frontward than the object A, and the object C is located more backward than the object A, the direction of the disparity vector of the object B (referred to as the disparity vector B, hereinafter) is leftward, and the direction of the disparity vector of the object C (referred to as the disparity vector C, hereinafter) is rightward.

In the step S13, the disparity vector B and the disparity vector C calculated in the step S12 are input into the 3D unfavorable object determining/extracting unit 153. Since it is possible to determine whether or not the object of interest is located more frontward than the main object based on the direction of its disparity vector, the 3D unfavorable object determining/extracting unit 153 extracts a candidate of the target object based on the direction of the disparity vector B and the direction of the disparity vector C. The target object is an object located more frontward than the cross point, so that the 3D unfavorable object determining/extracting unit 153 extracts, as the candidate of the target object, the object having the disparity vector whose direction is leftward, that is, the object B in the example of FIG. 5A to FIG. 5J.

In the step S14, the 3D unfavorable object determining/extracting unit 153 determines whether or not the disparity vector of the target object candidate extracted in the step S13 has a magnitude equal to or more than the threshold value.

In step S15, if the target object candidate has the disparity vector whose magnitude is equal to or more than the threshold value (YES in the step S14), the 3D unfavorable object determining/extracting unit 153 determines that the target object candidate is the target object. In the example of FIG. 5A to FIG. 5J, the object B is determined as the target object. The 3D unfavorable object determining/extracting unit 153 determines that the object B is an unfavorable object to be three-dimensionally displayed, and executes the following process of the step S18 and the step S19 on the object B.

If the target object candidate has the disparity vector whose magnitude is less than the predetermined threshold value (NO in the step S14), the 3D unfavorable object determining/extracting unit 153 omits the step 15, and shifts to the step 16.

In the step S16, the 3D unfavorable object determining/extracting unit 153 determines whether or not the process of the step S14 and the step S15 is executed on every target object candidate. If the process of the step S14 and the step S15 is not yet executed on every target object candidate (NO in the step S16), the 3D unfavorable object determining/extracting unit 153 executes the process of the step S14 and the step S15 once again.

In the step S17, if the process of the step S14 and the step S15 is executed on every target object candidate (YES in the step S16), the 3D unfavorable object determining/extracting unit 153 determines whether or not the determination of the presence of the target object is made in the process of the step S14 to the step S16.

If there exists no target object (NO in the step S17), the 3D unfavorable object determining/extracting unit 153 shifts to the step S20.

In the step S18, if there exists any target object (YES in the step S17), the background extracting unit 154 extracts the background image for the image for right-eye from the image for left-eye, and the image synthesizing unit 155 overlappingly (or, in a superimposed manner) synthesizes the background image for the image for right-eye on the target object image of the image for right-eye so as to delete the target object image from the right eye-image. The step S18 will be now described with reference to FIG. 5D to FIG. 5G. The process of the step S18 is carried out on the image for right-eye and on the image for left-eye after the parallax shifting to allow the positions of the main object to correspond with each other (setting the amount of the parallax to be 0) is carried out, as shown in FIG. 5B.

As shown in FIG. 5D, the background extracting unit 154 extracts the target object image (image of the object B in this example) along with its surrounding image from the image for right-eye. The extraction of the surrounding image may be performed by extracting an area in a rectangle, circle, or oval shape and so on including the object B (indicated by a dotted line in FIG. 5D).

As shown in FIG. 5E, the background extracting unit 154 searches the image for left-eye for an area including an image equivalent to the surrounding image of the object B extracted from the image for right-eye through a pattern matching method, for example. The area searched in this step has the substantially same size and shape as those of the area of the extracted surrounding image. The method used by the background extracting unit 154 is not limited to the pattern matching, and other various well-known methods may be used, instead.

As shown in FIG. 5F, the background extracting unit 154 extracts the background image for the image for right-eye from the area searched in FIG. 5E. This may be attained by extracting a portion including the object B in the area extracted in FIG. 5D (corresponding to the portion shaded by oblique lines in FIG. 5F) from the area searched in the image for left-eye of FIG. 5E (area surrounded by the dotted line in FIG. 5F). The background extracting unit 154 outputs the extracted background image to the image synthesizing unit 155.

As shown in FIG. 5G, the image synthesizing unit 155 overlaps the background image for the image for right-eye with the image of the object B in the image for right-eye to combine (synthesize) them. There is a parallax between the image for left-eye and the image for right-eye, and if the extracted background image is directly overwritten on the image for right-eye, a deviation (disconnect) is caused at the boundary of the background image. Hence, such a treatment is applied that blurs the boundary of the background image, or deforms the background image using morphing technique. Accordingly, the image of the object B (i.e., the target object image) is deleted from the image for right-eye.

In the step S19, along with the step S18, the image synthesizing unit 155 combines (synthesizes) the target object image with the image for left-eye, so as to overlappingly display the target object images in the image for left-eye. The synthesizing position in the image for left-eye is (corresponds with) the position where the target object is located in the image for right-eye. The step S19 will now be described with reference to FIG. 5H and FIG. 5I. As similar to the step S18, the process of the step S19 is carried out on the image for right-eye and on the image for left-eye after the parallax shifting to set the amount of the parallax of the main object to be 0 is carried out, as shown in FIG. 5B.

As shown in FIG. 5H, the image synthesizing unit 155 extracts the image of the object B from the image for right-eye. The image synthesizing unit 155 also extracts the image of the object B from the image for left-eye along with the position of the object B.

The disparity vector calculated in the step S12 is already input in the image synthesizing unit 155; thus the image synthesizing unit 155 now applies the synthesizing process to the left-eye data image such that the image of the object B extracted from the image for right-eye is combined (synthesized) with the image for left-eye at a position shifted by the disparity vector B from the position of the image of object B in the image for left-eye, as shown in FIG. 5I. In this way, the object B is displayed at two positions in the image for left-eye: at the position of the object B in the image for left-eye, and at the position shifted by the disparity vector B from the position of object B in the image for left-eye, that is, at a position corresponding to the position of the object B in the image for right-eye. Accordingly, the images of the object B (i.e., the target object image) are overlappingly displayed in the image for left-eye.

In the step S20, the image synthesizing unit 155 outputs to the three-dimensional image generating unit 133 the image for right-eye from which the image of the object B is deleted in the step S18, and the image for left-eye in which the images of the object B are overlappingly displayed in the step S19. The three-dimensional image generating unit 133 processes the image for right-eye from which the image of the object B is deleted in the step S18, and the image for left-eye in which the images of the object B are overlappingly displayed in the step S19 so as to be three-dimensionally displayed on the monitor 16, and output the processed image data to the monitor 16 through the video encoder 134.

Through this process, as shown in FIG. 5J, the image for right-eye whose image of the object B is deleted and the image for left-eye in which the images of the object B are overlappingly displayed are displayed on the monitor 16 as a three-dimensional image (reproduced as a single image). Since the image for right-eye displayed on the monitor 16 does not include the object B, the object B in the example of FIG. 5J does not appear three-dimensional. Accordingly, it is possible to attain a display preventing the object B from being excessively popping out.

The frame advance and return of the image is executed by using the right and the left keys of the cross button 26, and if the right key of the cross button 26 is pressed, a next image file is read out from the recording media 140, and is reproduced and displayed on the monitor 16. If the left key of the cross button 26 is pressed, a previous image file is read out from the recording media 140, and is reproduced and displayed on the monitor 16. The same process shown in FIG. 4 is executed on the next image file and the previous image file, and the 2D-processed image is displayed on the monitor 16 three-dimensionally.

While monitoring the images displayed on the monitor 16, the user can erase the images recorded on the recording media 140 if necessary. The image erasing is executed by pressing the MENU-OK button 25 while the image is reproduced and displayed on the monitor 16.

According to the present embodiment, it is possible to attain such a display that prevents the object having an excessive parallax in a direction popping out of the display plane from being viewed as a three-dimensional image (stereopsis is prevented). The excessive popping-out feeling thus can be prevented, which reduces the fatigue of the user's eyes. In addition, since 2D processing is not applied to the rest of the image other than the target object, it is possible to prevent difficulties in seeing a distance view.

In the present embodiment, the target object is extracted based on the magnitude and the direction of the disparity vector. However, the usage of the magnitude of the disparity vector is not essential for the extraction of the target object, and the extraction of the target object may be carried out based on only the direction of the disparity vector. In this case, such an object is extracted as the target object that is located more frontward than the cross point, and appears as if it is popping out from the display plane of the monitor 16, that is, has a parallax in the direction of popping out from the display plane. In some cases, the object may cause no fatigue to the user's eye depending on its amount of the popping-out from the display plane of the monitor 16, therefore, the extraction of the target object is preferably carried out based on the direction and the magnitude of the disparity vector.

The present embodiment carries out the following processes of: executing the parallax shifting to shift the image for right-eye by its amount of parallax, so that the main object has the parallax of 0 (matching the position of the main object with the cross point), calculating the disparity vector of each object based on the image for right-eye after the parallax shifting and on the image for left-eye, deleting the target object, and overlappingly displaying the images of the target object; but it is not essential to set the amount of the parallax of the main object to be 0. In this case, the disparity vector for each object is calculated based on the image for right-eye and the image for left-eye generated from the image signals output from the image sensors 122,123, then, the target object is deleted, and the images of the target object are overlappingly displayed. It should be noted that, if the parallax of the main object is set to be 0, the main object is displayed to be located on the display plane; thus the user's eyes are focused on the display plane when the user pays his or her attention to the main object. Consequently, it is preferable to set the amount of the parallax of the main object to be 0 in order to reduce the fatigue of the user's eye.

In the present embodiment, the parallax shifting is performed by shifting the image for right-eye by its amount of the parallax so as to set the amount of the parallax of the main object to be 0, but the magnitude of the parallax shifting (referred to as the amount of the parallax shifting, hereinafter) may be varied depending on the size of the target object. For example, if the ratio of the area occupied by the target object overlappingly displayed (referred to as the overlappingly displayed area, hereinafter) exceeds the threshold value, the amount of the parallax shifting is varied in the direction of reducing the amount of the popping-out, that is, in the direction for shifting the main object backward (in the direction for shifting the image for right-eye to the right in the present embodiment). In the example of FIG. 5A to FIG. 5J, the parallax shifting is carried out on the image for right-eye by using the amount of the parallax having a magnitude of “a” (the amount of the parallax shifting is +a) and a direction for shifting the image for right-eye to the right, but if the ratio occupied by the overlappingly displayed area exceeds the threshold value, the image for right-eye is further shifted to the right, so as to magnify the amount of the parallax shifting of the image for right-eye more than “a”. In this manner, the image for right-eye is shifted in the direction of reducing the amount of the popping-out from the display plane in general, thereby reducing the ratio occupied by the overlappingly displayed area. Since the disparity vector can be calculated to have a smaller value by changing the amount of the parallax shifting, the threshold value for the 2D processing becomes increased spuriously, thereby increasing the region used for the three-dimensional display.

Further, if the ratio occupied by the overlappingly displayed area exceeds the threshold value continuously in a certain time period, the amount of the parallax shifting may be gradually changed with time by shifting the main object in the direction of reducing the amount of the popping-out, that is, in the direction for shifting the main object backward. For example, in FIG. 5A to FIG. 5J, if the ratio occupied by the overlappingly displayed area exceeds the threshold value continuously in a certain time period, after the certain time period passes, the image for right-eye is further shifted to the right with time, so as to gradually increase the amount of the parallax shifting of the right-eye from the magnitude “a”. Through this process, the ratio occupied by the overlappingly displayed area can be gradually reduced with time. In addition, the region used for the three-dimensional display can also be gradually enlarged with time.

In the present embodiment, the overlapping display of the images of the target object is carried out on the image for left-eye, and the deletion of the target object is carried out on the right eye-image, but this process may be carried out with the image for left-eye and image for right-eye reversed.

### Second Embodiment

In the first embodiment of the present invention, the 2D processing is performed by overlappingly displaying the images of the target object in the image for left-eye, and deleting the target object from the image for right-eye, but the 2D processing is not limited to this.

The second embodiment of the present invention overlappingly displays the images of the target object in the image for left-eye and in the image for right-eye as the 2D processing. Hereinafter, description will be provided on the multi-eye digital camera 2 of the second embodiment. The same elements as those of the first embodiment are referred to by the same reference numerals, and description thereof will be omitted.

The major internal structure of the multi-eye digital camera 2 will now be described. A 3D/2D converter 135A is the only different feature of the multi-eye digital camera 2 from the multi-eye digital camera 1, therefore, only the 3D/2D converter 135A will be described.

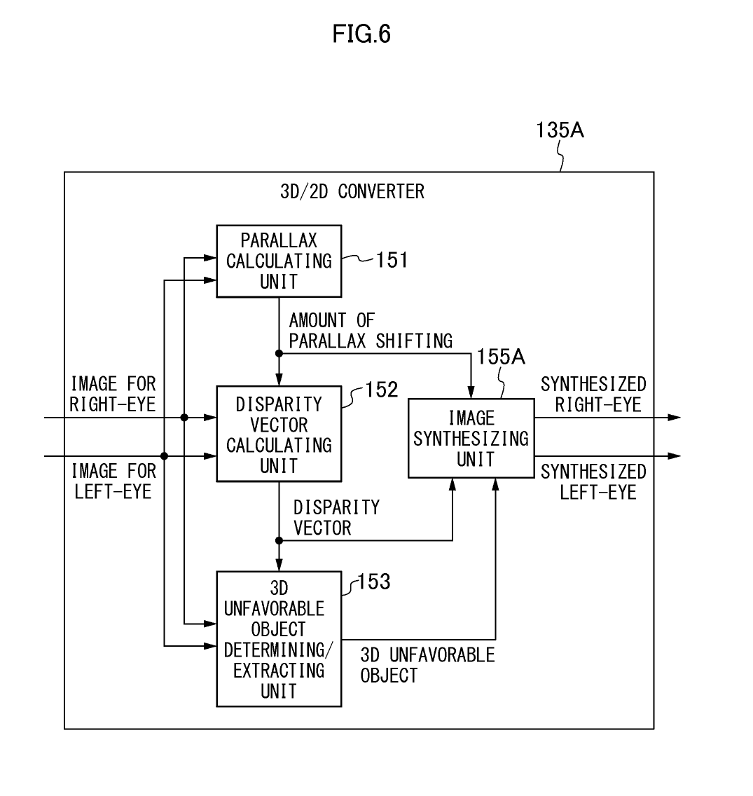

FIG. 6 is a block diagram showing the internal structure of the 3D/2D converter 135A. The 3D/2D converter 135A chiefly includes the parallax calculating unit 151, the disparity vector calculating unit 152, the 3D unfavorable object determining/extracting unit 153, and the image synthesizing unit 155A.

Based on the disparity vector input from the disparity vector calculating unit 152 and the information regarding the target object input from the 3D unfavorable object determining/extracting unit 153, the image synthesizing unit 155A makes the image of the target object semitransparent, and combines (synthesizes) this semitransparent image with the image for left-eye, so as to overlappingly display the images of the target object in the image for left-eye. The synthesizing position in the image for left-eye is (corresponds with) the position where the target object is located in the image for right-eye. Based on the disparity vector input from the disparity vector calculating unit 152 and the information regarding the target object input from the 3D unfavorable object determining/extracting unit 153, the image synthesizing unit 155A processes the image of the target object to be semitransparent, and combines (synthesizes) this semitransparent image with the image for right-eye, so as to overlappingly display the target object in the image for right-eye. The synthesizing position in the image for right-eye is (corresponds with) the position where the target object is located in the image for left-eye. Detailed description will be provided on the processing of the image synthesizing unit 155A.

Description will now be provided on the operations of the multi-eye digital camera 2. The 2D processing is the only different feature of the multi-eye digital camera 2 from the multi-eye digital camera 1; therefore, the 2D processing will be described with respect to the operations of the multi-eye digital camera 2.

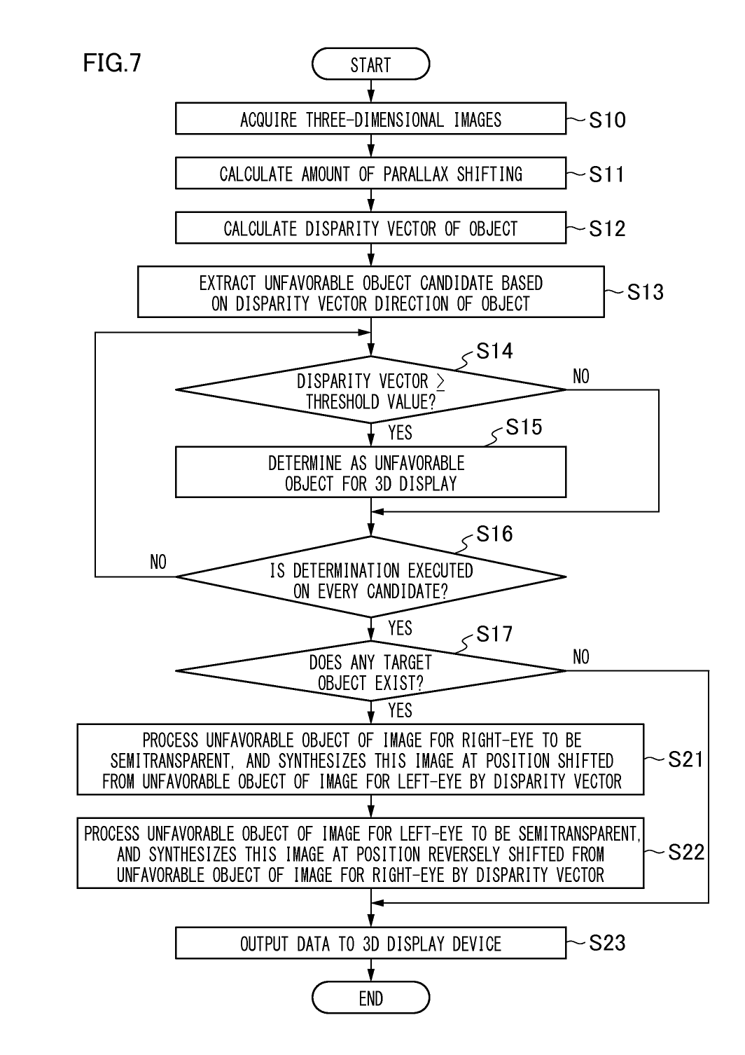

FIG. 7 is a flow chart showing a flow of the 2D processing applied to the target object on the 3D/2D converter 135A. The detailed description will be omitted on the same steps as those in FIG. 4.

In the step S10, the image data decompressed into uncompressed brightness-color difference signals on the compressing-decompressing unit 132, that is, the image for right-eye and the image for left-eye are input into the 3D/2D converter 135.

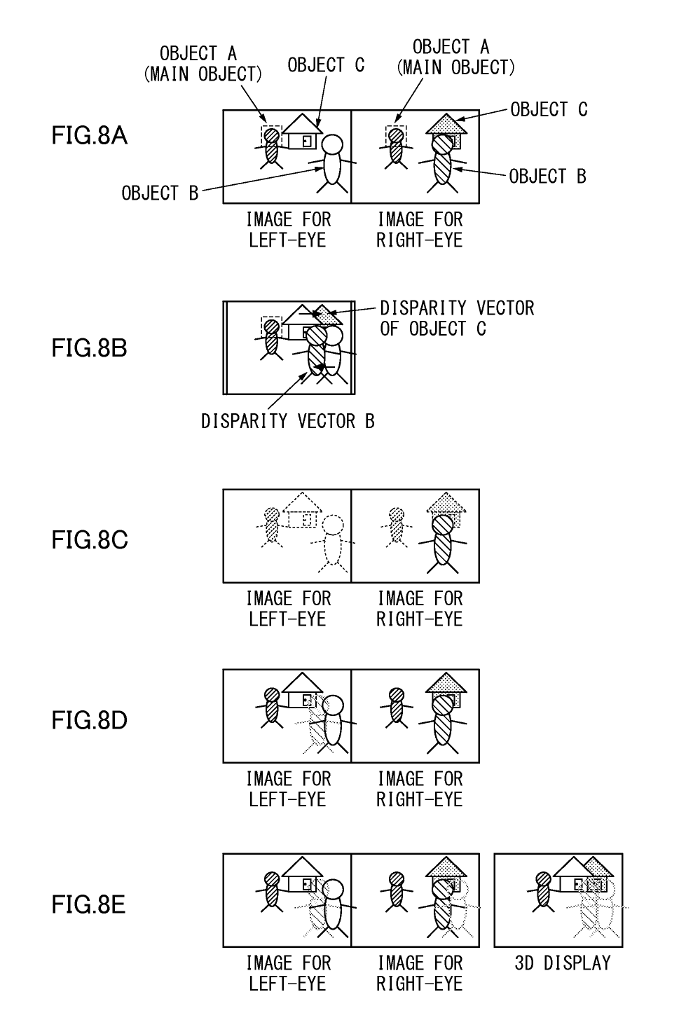

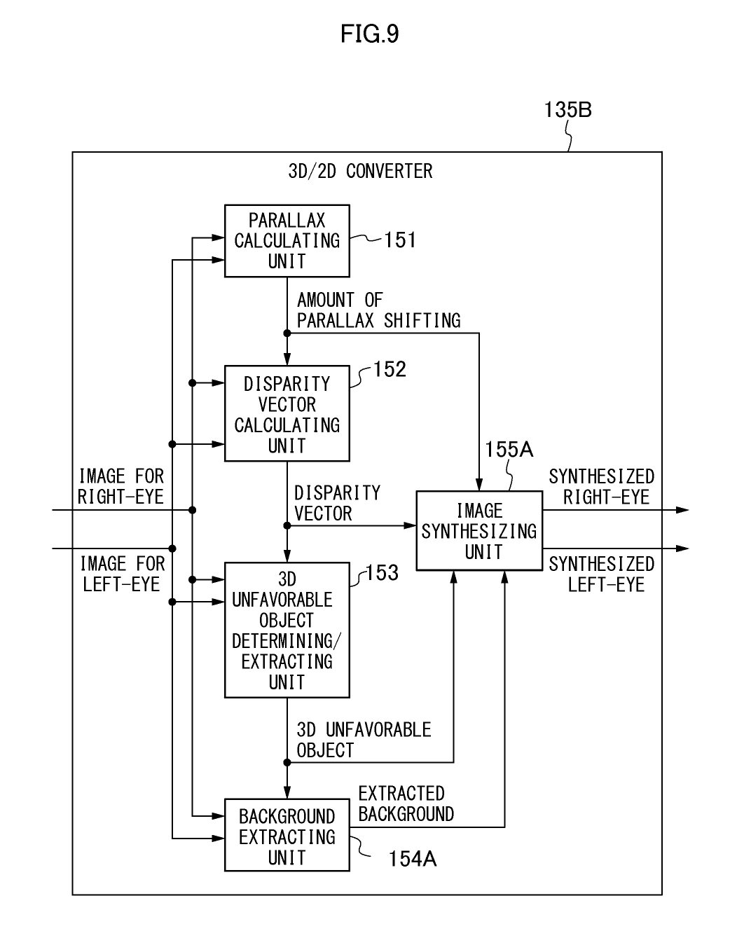

In the step S11, the parallax calculating unit 151 acquires the image for right-eye and the image for left-eye, and extracts the main object from the image for right-eye and from the image for left-eye, and then calculates the amount of the parallax of the main object. As shown in FIG. 8A, if an object A is the main object, the parallax calculating unit 151 compares the position of the object A in the image for left-eye to the position of the object A in the image for right-eye, so as to calculate the amount of the parallax of the object A. In FIG. 8A to FIG. 8E, the object B and the object C in the image for left-eye are shaded so as to distinguish the object B and the object C in the image for left-eye from the object B and the object C in the image for right-eye for a clear explanation. It is not meant that the object B and the object C in the image for right-eye are different from the object B and the object C in the image for left-eye.

In step S12, the amount of the parallax calculated in the step S11 is input into the vector calculating unit 152. As shown in FIG. 8B, the disparity vector calculating unit 152 executes the parallax shifting by shifting the image for right-eye by the amount of the parallax, and the disparity vector calculating unit 152 calculates a disparity vector for each object based on the image for right-eye and the image for left-eye after the parallax shifting is executed. In the example shown in FIG. 8A to FIG. 8E, the disparity vector of the object A becomes 0 as a result of the parallax shifting; therefore, the disparity vectors are calculated for the objects B and C.

In the step S13, the disparity vector B and the disparity vector C calculated in the step S12 are input into the 3D unfavorable object determining/extracting unit 153. The 3D unfavorable object determining/extracting unit 153 extracts a candidate of the target object based on the directions of the disparity vectors.

In the step S14, the 3D unfavorable object determining/extracting unit 153 determines whether or not the disparity vector of the target object candidate extracted in the step S13 has a magnitude equal to or more than the threshold value.

In step S15, if the target object candidate has the disparity vector whose magnitude is equal to or more than the threshold value (YES in the step S14), the 3D unfavorable object determining/extracting unit 153 determines that the target object candidate is the target object. In the example of FIG. 8A to FIG. 8E, the object B is determined as the target object. The 3D unfavorable object determining/extracting unit 153 determines that the object B is an unfavorable object to be three-dimensionally displayed, and executes the following process of the step S21 and the step S22 on the object B.

If the target object candidate has a disparity vector less than the predetermined threshold value (NO in the step 14), the 3D unfavorable object determining/extracting unit 153 omits the step S15, and shifts to the step S16.

In the step S16, the 3D unfavorable object determining/extracting unit 153 determines whether or not the process of the step S14 and the step S15 is executed on every target object candidate. If the process of the step S14 and the step S15 is not yet executed on every target object candidate (NO in the step S16), the 3D unfavorable object determining/extracting unit 153 executes the process of the step S14 and the step S15 once again.

In the step S17, if the process of the step S14 and the step S15 is executed on every target object candidate (YES in the step S16), the 3D unfavorable object determining/extracting unit 153 determines whether or not the determination of the presence of the target object is made in the process of the step S14 to the step S16.

If there exists no target object (NO in the step S17), the 3D unfavorable object determining/extracting unit 153 shifts to the step S23.

In the step S21, there exists any target object (YES in the step S17), the image synthesizing unit 155A processes the images of the target object to be semitransparent, and synthesizes this semitransparent image in the image for left-eye, so as to overlappingly display the images of the target object in the image for left-eye. The synthesizing position in the image for left-eye is (corresponds with) the position where the target object is located in the image for right-eye. The step S21 will now be described with reference to FIG. 8C and FIG. 8D. The process of the step S21 is carried out on the image for right-eye after the parallax shifting for setting the amount of the parallax of the main object to 0 and on the image for left-eye, as shown in FIG. 8B.

As shown in FIG. 8C, the image synthesizing unit 155A extracts the image of the object B from the image for right-eye. The image synthesizing unit 155A also extracts the image of the object B from the image for left-eye along with the position of the object B.

The disparity vector calculated in the step S12 is already input in the image synthesizing unit 155A; thus the image synthesizing unit 155A now applies the combining process (synthesizing process) in which the image of the object B extracted from the image for right-eye is made semitransparent and this semitransparent image is combined with the image for left-eye at a position shifted by the disparity vector B from the position of the image of object B in the image for left-eye, as shown in FIG. 8D.

The processing of making the image semitransparent and combining (synthesizing) the semitransparent image are attained by defining weighting between pixels of the object B extracted from the image for right-eye as the synthesizing target and pixels of the image for left-eye as the non-synthesizing target, and superimposing the object B extracted from the image for right-eye to the image for left-eye using the weighting. The weighting may be defined at any value, and the degree of semitransparency can be appropriately defined by varying the weighting.

In this way, the images of the object B are displayed at two positions in the image for left-eye: at the position of the object B in the image for left-eye, and at the position shifted by the disparity vector B from the position of the object B in the image for left-eye, that is, at the position corresponding to the position of the object B in the image for right-eye. This means that the images of the target object are overlappingly displayed in the image for left-eye.

In the step S22, as similar to the step S21, the image synthesizing unit 155A processes the image of the target object to be semitransparent, and combines (synthesizes) this semitransparent image with the image for right-eye, so as to overlappingly display the images of the target object in the image for right-eye. The synthesizing position in the image for right-eye is (corresponds with) the position where the target object is located in the image for left-eye. The image synthesizing unit 155A extracts the image of the object B from the image for left-eye, and also extracts the image of the object B from the image for right-eye along with the position of the object B. Then, the image synthesizing unit 155A applies the following process in which the image of the object B extracted from the image for left-eye is made semitransparent, and this semitransparent image is combined (synthesized) with the image for right-eye at the position shifted from the position of the object B in the image for right-eye by the disparity vector B in a direction opposite to the direction of the disparity vector B. In this way, the images of the object B are displayed at two positions in the image for right-eye: at the position of the object B in the image for right-eye, and at the position shifted from the position of the object B in the image for right-eye by the disparity vector B in the reverse direction to the direction of the disparity vector B in the image for right-eye, that is, at the position corresponding to the position of the object B in the image for left-eye. This means that the images of the target object are overlappingly displayed in the image for right-eye. As similar to the step S21, the process of the step S22 is carried out on the image for right-eye after the parallax shifting to set the amount of the parallax of the main object to be 0, and on the image for left-eye, as shown in FIG. 8B.

In the step S23, the image synthesizing unit 155A outputs to the three-dimensional image generating unit 133 the image for right-eye and the image for left-eye, in which the images of the object B are overlappingly displayed in the step S21 and the step S22. The three-dimensional image generating unit 133 processes the image for right-eye and the image for left-eye, in each of which the images of the object B are overlappingly displayed in the step S21 and the step S22, so as to be three-dimensionally displayed on the monitor 16, and outputs the processed image data to the monitor 16 through the video encoder 134.

Through this process, as shown in FIG. 8E, the image for right-eye and the image for left-eye in each of which the images of the object B are overlappingly displayed are displayed on the monitor 16 as a three-dimensional image (reproduced as a single image). Since each of the image for right-eye and the image for left-eye displayed on the monitor 16 includes the object B, the object B is three-dimensionally displayed. The semitransparent image of the object B not used in the three-dimensional display is located beside the image of the object B used in the three-dimensional display, thereby interrupting the user's consciousness and reducing the three-dimensional effect of the object B.

According to the present embodiment, the target object is hindered from being viewed as a three-dimensional image, thereby reducing the three-dimensional effect of the object having an excessive popping out feeling. Accordingly, it is possible to reduce the fatigue of the user's eyes.

### Third Embodiment

In the second embodiment of the present invention, the target object processed to be semitransparent is synthesized so as to be overlappingly displayed in the image for left-eye and in the image for right-eye, but the 2D processing is not limited to this.

In 2D processing of the third embodiment of the present invention, the photographed target object is processed to be semitransparent and this semitransparent image is synthesized, so that the semitransparent images of the target object are overlappingly displayed in the image for left-eye and in the image for right-eye. Hereinafter, description will be provided on the multi-eye digital camera 3. The same elements as those of the first embodiment and the second embodiment are referred to by the same reference numerals, and description thereof will be omitted.

The major internal structure of the multi-eye digital camera 2 will now be described. A 3D/2D converter 135B is the only different feature of the multi-eye digital camera 3 from the multi-eye digital camera 1; therefore, only the 3D/2D converter 135B will be described.

FIG. 9 is a block diagram showing the internal structure of the 3D/2D converter 135B. The 3D/2D converter 135B chiefly includes the parallax calculating unit 151, the disparity vector calculating unit 152, the 3D unfavorable object determining/extracting unit 153, the background extracting unit 154A, and the image synthesizing unit 155A.

The background extracting unit 154A extracts the background image for the image for right-eye, from the image for left-eye. The background extracting unit 154A extracts the background image of the target object in the image for left-eye (referred to as the background image for the image for left-eye, hereinafter) from the image for right-eye. The background image for the image for right-eye extracted by the background extracting unit 154A is input into the image synthesizing unit 155A. The background extracting unit 154A will be described in detailed later.

Description will now be provided on the operations of the multi-eye digital camera 3. The 2D processing is the only different feature of the multi-eye digital camera 3 from the multi-eye digital camera 1; therefore, the 2D processing will be described with respect to the operations of the multi-eye digital camera 3.

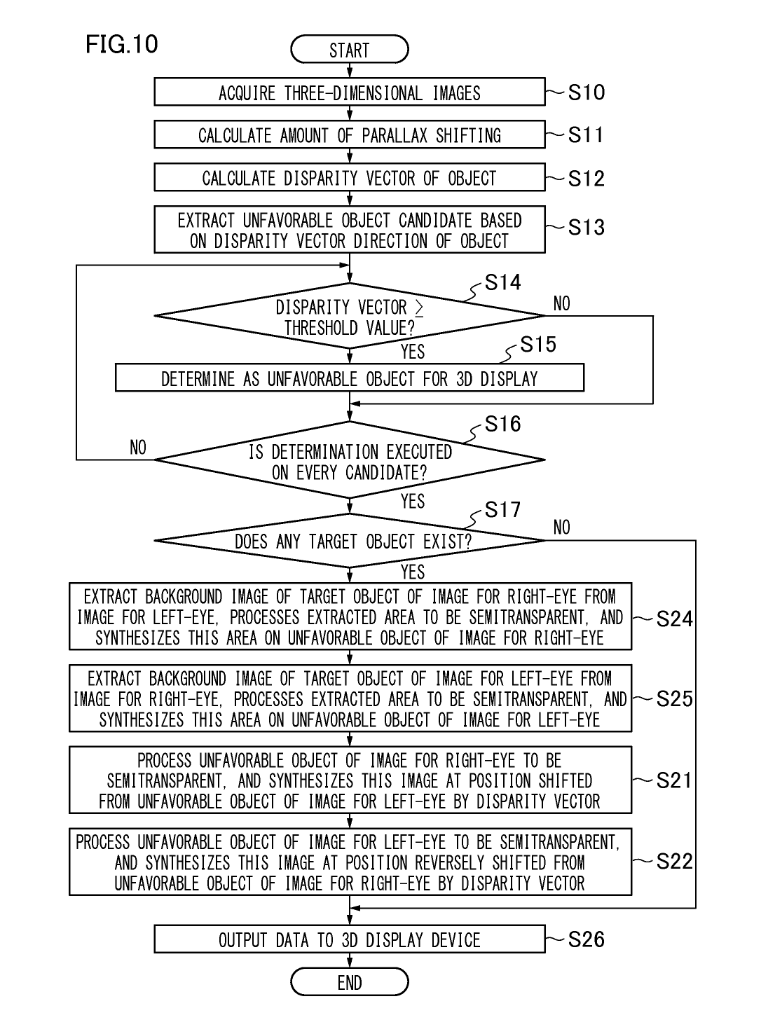

FIG. 10 is a flow chart showing a flow of the 2D processing applied to the target object on the 3D/2D converter 135B. The detailed description will be omitted on the same steps as those in FIG. 4 and FIG. 7.

In the step S10, the image data decompressed into the uncompressed brightness-color difference signals on the compressing-decompressing unit 132, that is, the image for right-eye and the image for left-eye are input into the 3D/2D converter 135.

In the step S11, the parallax calculating unit 151 acquires the image for right-eye and the image for left-eye, and extracts the main object from the image for right-eye and from the image for left-eye, and then calculates the amount of the parallax of the main object. As shown in FIG. 11A, if an object A is the main object, the parallax calculating unit 151 compares the position of the object A in the image for left-eye to the position of the object A in the image for right-eye, so as to calculate the parallax of the object A. In FIG. 11A to FIG. 11K, the object B and the object C in the image for left-eye are shaded so as to distinguish the object B and the object C in the image for left-eye from the object B and the object C in the image for right-eye for a clear explanation. It is not meant that the object B and the object C in the image for right-eye are different from the object B and the object C in the image for left-eye.

In step S12, the amount of the parallax calculated in the step S11 is input into the vector calculating unit 152. As shown in FIG. 11B, the disparity vector calculating unit 152 executes the parallax shifting by shifting the image for right-eye by the amount of the parallax, and the disparity vector calculating unit 152 calculates a disparity vector for each object based on the image for right-eye and the image for left-eye after the parallax shifting is executed. In the example shown in FIG. 11A to FIG. 11K, the disparity vector of the object A is 0 through the parallax shifting; therefore, the disparity vectors are calculated for the objects B and C.

In the step S13, the disparity vector B and the disparity vector C calculated in the step S12 are input into the 3D unfavorable object determining/extracting unit 153. The 3D unfavorable object determining/extracting unit 153 extracts a candidate of the target object based on the directions of the disparity vectors.

In the step S14, the 3D unfavorable object determining/extracting unit 153 determines whether or not the disparity vector of the target object candidate extracted in the step S13 has a magnitude equal to or more than the threshold value.

In step S15, if the target object candidate has the disparity vector whose magnitude is equal to the predetermined threshold value or more (YES in the step S14), the 3D unfavorable object determining/extracting unit 153 determines that the target object candidate is the target object. In the example of FIG. 11A to FIG. 11K, the object B is determined as the target object. The 3D unfavorable object determining/extracting unit 153 determines that the object B is an unfavorable object to be three-dimensionally displayed, and executes the following process of the step S21, the step S22, the step S24, and the step S25 on the object B.

If the target object candidate has a disparity vector less than the predetermined threshold value (NO in the step 14), the 3D unfavorable object determining/extracting unit 153 omits the step S15, and shifts to the step S16.

In the step S16, the 3D unfavorable object determining/extracting unit 153 determines whether or not the process of the step S14 and the step S15 is executed on every target object candidate. If the process of the step S14 and the step S15 is not yet executed on every target object candidate (NO in the step S16), the 3D unfavorable object determining/extracting unit 153 executes the process of the step S14 and the step S15 once again.

In the step S17, if the process of the step S14 and the step S15 is executed on every target object candidate (YES in the step S16), the 3D unfavorable object determining/extracting unit 153 determines whether or not the determination of the presence of the target object is made in the process of the step S14 to the step S16.

If there exists no target object (NO in the step S17), the 3D unfavorable object determining/extracting unit 153 shifts to the step S20.

In the step S24, if there exists any target object (YES in the step S17), the background extracting unit 154A extracts the background image for the image for right-eye from the image for left-eye, and the image synthesizing unit 155A processes the background image for the image for right-eye to be semitransparent, and combines (synthesizes) this semitransparent image with the image for right-eye. The step S24 will now be described with reference to FIG. 11C to FIG. 11F. The process of the step S24 is carried out on the image for right-eye after the parallax shifting to set the amount of the parallax of the main object to be 0 and on the image for left-eye, as shown in FIG. 11B.

As shown in FIG. 11C, the background extracting unit 154A extracts the target object image (image of the object B in this example) along with its surrounding image from the image for right-eye. The extraction of the surrounding image may be performed by extracting an area in a rectangle, circle, or oval shape including the object B (indicated by a dotted line in FIG. 11C).

As shown in FIG. 11D, the background extracting unit 154A searches the image for left-eye for an area including an image equivalent to the surrounding image of the object B extracted from the image for right-eye through the pattern matching method, for example. The area searched in this step is the substantially same as the area of the extracted surrounding image.

As shown in FIG. 11E, the background extracting unit 154A extracts the background image for the image for right-eye from the area searched in FIG. 11D. This may be attained by extracting a portion including the object B in the area extracted in FIG. 11C (corresponding to the portion shaded by oblique lines in FIG. 11E) from the area searched in the image for left-eye of FIG. 11D. The background extracting unit 154A outputs the extracted background image to the image synthesizing unit 155A.

As shown in FIG. 11F, the image synthesizing unit 155A processes the background image for the image for right-eye to be semitransparent, and overlaps this semitransparent background image on the image of the object B in the image for right-eye to combine (synthesize) them. There is a parallax between the image for left-eye and the image for right-eye, and if the extracted background image is directly overwritten on the image for right-eye, a deviation is caused at the boundary of the background image. Hence, such a treatment is applied that blurs the boundary of the background image, or deforms the background image using morphing technique.

The processing of making the image semitransparent and synthesizing this semitransparent image is attained by defining weighting between pixels of the background image for the image for right-eye as the synthesizing target and pixels of the object B of the image for right-eye as the non-synthesizing target, and superimposing the background image for the image for right-eye to the object B of the image for right-eye using the weighting. The weighting may be defined at any value, and the degree of semitransparency (referred to as a transmission rate, hereinafter) can be appropriately defined by varying the weighting. Accordingly, the background image is processed to be semitransparent, and synthesized in the image for right-eye.

In the step S25, as similar to the step S24, the background extracting unit 154A extracts the background image for the image for left-eye from the image for right-eye, and the image synthesizing unit 155 processes the background image for the image for left-eye to be semitransparent, and combines (synthesizes) this semitransparent image with the image for left-eye. The process of the step S25 is carried out on the image for right-eye after the parallax shifting for setting the amount of the parallax of the main object to be 0 and on the image for left-eye, as shown in FIG. 11B.

The background extracting unit 154A extracts the target object (image of the object B in this example) along with its surrounding image from the image for left-eye, and searches the image for right-eye for an area including an image equivalent to the extracted surrounding image of the object B through the pattern matching method, and extracts the background image for the image for left-eye from the area searched in the image for right-eye. The image synthesizing unit 155A overlaps the background image for the image for left-eye on the image of the object B in the image for left-eye to combine (synthesize) them. Accordingly, the background image is processed to be semitransparent, and synthesized in the image for left-eye, as shown in FIG. 11G.

In the step S21, along with the step S18 and the step S24, the image synthesizing unit 155A processes the target object image to be semitransparent, and combines (synthesizes) this semitransparent target object image with the image for left-eye, so as to overlappingly display the target object images in the image for left-eye, as shown in FIG. 11H and FIG. 11I (the same as FIG. 8C and FIG. 8D). The synthesizing position in the image for left-eye is (corresponds with) the position where the target object is located in the image for right-eye. In this way, the images of the object B are overlappingly displayed in the image for right-eye. The process of the step S21 is carried out on the image for right-eye after the parallax shifting for setting the amount of the parallax of the main object to 0 and on the image for left-eye, as shown in FIG. 11B.

In the step S22, as similar to the step S21, the image synthesizing unit 155A processes the target object image to be semitransparent, and combines (synthesizes) this semitransparent target object image with the image for right-eye, so as to overlappingly display the images of the target object in the image for right-eye, as shown in FIG. 11J (the same as FIG. 8E). The synthesizing position in the image for right-eye is (corresponds with) the position where the target object is located in the image for left-eye. In this way, the images of the object B are overlappingly displayed in the image for right-eye. As similar to the step S21, the process of the step S22 is carried out on the image for right-eye after the parallax shifting for setting the amount of the parallax of the main object to 0 and on the image for left-eye, as shown in FIG. 11B.

In the step S26, the image synthesizing unit 155A outputs to the three-dimensional image generating unit 133 the image for right-eye and the image for left-eye whose background images are processed to be semitransparent and synthesized in the step S24 and in the step S25, and also outputs the image for right-eye and the image for left-eye in each of which the images of the target object are overlappingly displayed in the step S21 and the step S22.

The three-dimensional image generating unit 133 combines (synthesizes) the image for left-eye in which the images of the object B are overlappingly displayed in the step S21 with the image for left-eye whose background image is made semitransparent and synthesized in the step S25. As a result, as shown in FIG. 11K, the two images of the object B displayed in the image for left-eye are processed to be semitransparent, respectively. The three-dimensional image generating unit 133 also combines (synthesizes) the image for right-eye in which the images of the object B are overlappingly displayed in the step S22 with the image for right-eye whose background image is processed to be semitransparent and is synthesized in the step S24. As a result, as shown in FIG. 11K, the two images of the object B displayed in the image for right-eye are processed to be semitransparent, respectively.

The three-dimensional image generating unit 133 processes the image for right-eye and the image for left-eye, in each of which the images of the target object (the images of the object B in this case) displayed side by side are processed to be semitransparent, respectively, so as to be three-dimensionally displayed on the monitor 16, and outputs the processed image data to the monitor 16 through the video encoder 134.

Through this process, as shown in FIG. 11K, the image for right-eye and the image for left-eye in each of which the images of the object B are processed to be semitransparent and overlappingly displayed are displayed on the monitor 16 as a three-dimensional image (reproduced as a single image). Since each of the image for right-eye and the image for left-eye displayed on the monitor 16 includes the photographed object B, the object B is three-dimensionally displayed. The image of the object B used in the three-dimensional display, however, is semitransparent, so that the user becomes unlikely to look at the object B. In addition, the image of the object B not used in the three-dimensional display is semitransparent and displayed beside the image of the object B used in the three-dimensional display, thereby interrupting the user's consciousness. As a result, the three-dimensional effect of the object B can be reduced.

According to the present embodiment, the target object is hindered from being viewed as a three-dimensional image, thereby reducing the three-dimensional effect of the object having an excessive popping out feeling. Accordingly, it is possible to reduce the fatigue of the user's eyes.

In the present embodiment, in each of the image for left-eye and the image for right-eye, the images of the target object are made semitransparent and displayed side by side to thereby perform 2D processing. However, the process in which images of the target object is made semitransparent and displayed side by side may be performed on one of the image for left-eye and the image for right-eye. For example, as shown in FIG. 12, the images of the target object may be processed to be semitransparent, and are displayed side by side only in the image for left-eye, and the images of the target object may be deleted from the image for right-eye. In this case, instead of executing the process from the step S24 to the step S22 of FIG. 10, the background image is extracted from the image for right-eye so as to delete the target object (the step S18), the background image is processed to be semitransparent, and combined (synthesized) with the image for left-eye, so as to make the target object image semitransparent (step S25), and the target object image may be processed to be semitransparent, and be synthesized in the image for left-eye, so as to overlappingly display the images of the target object in the image for left-eye (the step S21). Alternatively, instead of executing the process of the step S26 of FIG. 10, the following image for left-eye and image for right-eye is processed so as to be three-dimensionally displayed on the monitor 16, and these processed image data is output to the monitor 16 through the video encoder 134: the image for left-eye generated by combining (synthesizing) the image for left-eye in which the images of the target object are overlappingly displayed in the step S21 with the image for left-eye whose background image is made semitransparent and synthesized in the step S25, i.e., the image for left-eye in which the two images of the target object displayed side by side are semitransparent, and the image for right-eye in which the image of the target object is deleted in the step S18.

In the variation shown in FIG. 12, only one of the images of the target object displayed side by side in the left image, which is located at the position corresponding to the position thereof in the image for right-eye, may be semitransparent. In this case, instead of executing the process of the step S24 to S22, the background image is extracted from the image for right-eye so as to delete the target object (the step S18), and the target object image is processed to be semitransparent and combined (synthesized) with the image for left-eye, so as to overlappingly display the images of the target object (the step S21), and these image data may be processed to be three-dimensionally displayed on the monitor 16, and be outputted to the monitor 16 through the video encoder 134.

In the present embodiment, the transmission rate used in processing the target object image to be semitransparent, and synthesizing this semitransparent image may be varied depending on the size of the target object. For example, the transmission rate may be increased as the size of the target object becomes greater. In this case, the image synthesizing unit 155A may acquire the size of the extracted target object extracted from the disparity vector calculating unit 152, and defines the transmission rate based on the relation between the size of the target object and the transparency, which is stored on the storage area (not shown) of the image synthesizing unit 155A. This configuration may be applicable not only to the variation of the third embodiment, but also to variations of the second and third embodiments.

The first to the third embodiments have been explained by using the examples of the processing to display the images on the monitor 16 of the multi-eye digital camera, but the present invention may be applicable to another case of outputting images photographed by a multi-eye digital camera to a display device such as a portable personal computer or a monitor having a three-dimensional displaying function, and three-dimensionally viewing the images on the portable personal computer or the monitor having a three-dimensional displaying function. Specifically, the present invention may be applicable to a device such as a multi-eye digital camera and a display device, and may also be applicable to a program installed in such a device and executed by this device.

The first to the third embodiments have been explained by using the example of a compact portable display device, that is, the monitor 16 of the multi-eye digital camera, but the present invention may be applicable to a large display device such as a television set and a projector screen. The present invention, however, is more effective if it is applied to a compact display device.

The first to the third embodiments have been explained by using an example of photographing still images, but the present invention may be also applicable to the case of photographing through images or moving images. In the case of using through images or moving images, the main object may be selected in the same manner as that in the case of using still images, or a moving object in chase (user's selection, etc.) may be selected as the main object. A moving object in chase during photographing of through images conducted prior to photographing of still images may be selected as the main object in the photographing of the still images.

In the case of the photographing moving images, instead of the determination process of determining the target object candidate having a disparity vector equal to or more than the predetermined threshold value (the step S15) as the target object, it may be determined that the target object candidate having a disparity vector equal to or more than the predetermined threshold value in a certain time period is the target object. This configuration prevents a problem such as a hunting that causes an unstable overlapping display due to the magnitude of the disparity vector of the target object candidate that fluctuates around the predetermined threshold value.

The present invention may also be realized by using a program. In this case, such a program is prepared that allows a computer to execute the three-dimensional display processing according to the present invention, and this program is installed in the computer, and then this program is executed on the computer. The program that allows the computer to execute the three-dimensional display processing according to the present invention may be stored on a recording medium, and this program may be installed to the computer through the recording medium. Examples of the recording medium may include a magneto-optical disk, a flexible disk, and a memory chip, etc.

What is claimed is:

1. A three-dimensional image display device comprising:
an acquiring units for acquiring an image for left-eye and an image for right-eye;
a display unit for recognizably displaying the image for left-eye and the image for right-eye as a three-dimensional image;
a target object extracting unit for extracting from each of the image for left-eye and the image for right-eye an object (referred to as a target object, hereinafter) having a parallax in a direction of popping out from a display plane of the display unit when the image for left-eye and the image for right-eye are displayed on the display unit;
an image processing unit for carrying out image processing on the image for left-eye and on the image for right-eye based on the target object extracted by the target object extracting unit, on one of the image for left-eye and the image for right-eye (referred to as a first image, hereinafter), the image processing unit perform a process of displaying an image of the target object (referred to as a target object image, hereinafter) at two positions, one of which is a position of the target object in the image for left-eye, and the other of which is a position of the target object in the image for right-eye (referred to as a process of overlappingly displaying the target object images, hereinafter), and the image processing unit carrying out a process of deleting the target object image from an image other than the first image of the image for left-eye and the image for right-eye (referred to as a second image, hereinafter), or perform a process of overlappingly displaying the target object images in the image for left-eye and in the image for right-eye; and
a display controlling unit for displaying the image for left-eye and the image for right-eye to both of which the image processing is applied by the image processing unit.

2. The three-dimensional image display device according to claim 1, wherein
the target object extracting unit extracts as the target object an object whose parallax in the direction of popping out from the display plane of the display unit is equal to or more than a predetermined magnitude.

3. The three-dimensional image display device according to claim 1, further comprising:
a main object extracting unit for extracting at least one main object from each of the image for left-eye and the image for right-eye; and
a parallax shifting unit for shifting one of the image for left-eye and the image for right-eye in a horizontal direction so as to make a position of the main object in the image for left-eye correspond with a position of the main object in the image for right-eye, wherein
the target object extracting unit extracts the target object from one of the image for left-eye and the image for right-eye after the parallax shifting performed by the parallax shifting unit, and
the image processing unit displays the target object image at two positions, one of which is a position of the target object in the image for left-eye after the parallax shifting is performed by the parallax shifting unit, and the other of which is a position of the target object in the image for right-eye after the parallax shifting is performed by the parallax shifting unit, so as to overlappingly display the target object images.

4. The three-dimensional image display device according to claim 1, further comprising
a disparity vector calculating unit that extracts a predetermined object from each of the image for left-eye and the image for right-eye, calculates a disparity vector indicating a deviation of a position of the predetermined object in the second image relative to a position of the predetermined object in the first image as a disparity vector of the predetermined object and executes the disparity vector calculation on every object included in the image for left-eye and in the image for right-eye, wherein
the target object extracting unit extracts the target object based on the disparity vector calculated on the disparity vector calculating unit.

5. The three-dimensional image display device according to claim 4, wherein
the image processing unit includes
a device for extracting the target object image from the first image, and synthesizing the target object image at a position shifted from the target object image extracted from the first image by a disparity vector calculated for the target object on the disparity vector calculating unit, so as to overlappingly display the target object images in the first image; and
a device for extracting the target object image and an image of surroundings of the target object image from the second image, extracting a background of the target object of the second image (referred to as a background image, hereinafter) from the first image based on the image of the surroundings extracted from the second image, and synthesizing the background image extracted from the first image on the target object image extracted from the second image, so as to delete the target object image from the second image.

6. The three-dimensional image display device according to claim 5, wherein
the image processing unit extracts the target object image from the first image, processes the target object image to be semitransparent, and synthesizes the semitransparent target object image at a position shifted from the target object image extracted from the first image by the disparity vector calculated for the target object on the disparity vector calculating unit, so as to overlappingly display the target object images in the first image.

7. The three-dimensional image display device according to claim 4, wherein
the image processing unit extracts the target object image from the first image, processes the target object image to be semitransparent, and synthesizes the semitransparent target object image at a position shifted from the target object image extracted from the first image by a disparity vector calculated for the target object on the disparity vector calculating unit (referred to as a disparity vector of the target object, hereinafter); and extracts the target object image from the second image, processes the target object image to be semitransparent, and synthesizes the semitransparent target object image at a position shifted from the target object image extracted from the second image in a reverse direction to the disparity vector of the target object by a magnitude of the disparity vector of the target object, so as to overlappingly display the target object images in each of the first image and the second image.

8. The three-dimensional image display device according to claim 4, wherein
the image processing unit comprises:
a device for extracting the target object image from the first image, processing the target object image to be semitransparent, and synthesizing the semitransparent target object image at a position shifted from the target object image extracted from the first image by a disparity vector calculated for the target object on the disparity vector calculating unit (referred to as a disparity vector of the target object, hereinafter), and extracting the target object from the second image, processing the target object image to be semitransparent, and synthesizing the semitransparent target object image at a position shifted from the target object image extracted from the second image in a reverse direction to the disparity vector of the target object by a magnitude of the disparity vector of the target object; and
a device for extracting the target object image and an image of surroundings of the target object image from the second image, extracting a background of the target object of the second image (referred to as a background image, hereinafter) from the first image based on the image of the surroundings extracted from the second image, processing the background image extracted from the first image to be semitransparent, and overlappingly synthesizing the semitransparent background image on the target object image extracted from the second image, and extracting the target object image and an image of surroundings of the target object image from the first image, extracting a background image of the first image from the second image based on the image of the surroundings extracted from the first image, processing the background image extracted from the second image to be semitransparent, and overlappingly synthesizing the semitransparent background image on the target object image extracted from the first image.

9. The three-dimensional image display device according to claim 6, wherein
the image processing unit varies a degree of the semitransparency based on a size of the target object.

10. A three-dimensional image display method comprising:
a step of acquiring an image for left-eye and an image for right-eye;
a step of extracting from each of the image for left-eye and the image for right-eye at least one object having a parallax in a direction of popping out from a display plane of the display unit (referred to as a target object image, hereinafter) when the image for left-eye and the image for right-eye are displayed on a display unit for recognizably displaying the image for left-eye and the image for right-eye as a three-dimensional image;
a step of carrying out image processing on the image for left-eye and on the image for right-eye based on the extracted target object;
a step of carrying out, on one of the image for left-eye and the image for right-eye (referred to as a first image, hereinafter), a process of displaying an image of the target object (referred to as a target object image, hereinafter) at two positions, one of which is a position of the target object in the image for left-eye, and the other of which is a position of the target object in the image for right-eye (referred to as a process of overlappingly displaying the target object images, hereinafter), and carrying out a process of deleting the target object from an image other than the first image of the image for left-eye and the image for right-eye (referred to as a second image, hereinafter), or a process of overlappingly displaying the target object images in the image for left-eye and in the image for right-eye; and
a step of displaying the image for left-eye and the image for right-eye to both of which the image processing is applied on the displaying unit.

11. A computer-readable recording medium storing a computer program including instructions executable by a computer,
the computer program realizing on one or more computers:
a function of acquiring an image for left-eye and an image for right-eye;
a function of extracting from each of the image for left-eye and the image for right-eye at least one object having a parallax in a direction of popping out from a display plane of the display unit (referred to as a target object image, hereinafter) when the image for left-eye and the image for right-eye are displayed on a display unit for recognizably displaying the image for left-eye and the image for right-eye as a three-dimensional image;
a function of carrying out image processing on the image for left-eye and the image for right-eye based on the extracted target object;
a function of carrying out, on one of the image for left-eye and the image for right-eye (referred to as a first image, hereinafter), a process of displaying an image of the target object (referred to as a target object image, hereinafter) at two positions, one of which is a position of the target object in the image for left-eye, and the other of which is a position of the target object in the image for right-eye (referred to as a process of overlappingly displaying the target object images, hereinafter), and carrying out a process of deleting the target object image from an image other than the first image of the image for left-eye and the image for right-eye (referred to as a second image, hereinafter), or a process of overlappingly displaying the target object images in the image for left-eye and in the image for right-eye; and
a function of displaying the image for left-eye and the image for right-eye to both of which the image processing is applied.
